(19) United States
(12) Patent Application Publication
(10) Pub. No.: US 2026/0003981 A1
(43) Pub. Date: Jan. 1, 2026

(54) METHODS AND APPARATUS FOR SECURE TRANSFER OF CRYPTOGRAPHIC DATA SEGMENTS

(71) Applicant: David MCNAUGHT, Menlo Park, CA (US)

(72) Inventor: David MCNAUGHT, Menlo Park, CA (US)

(21) Appl. No.: 19/321,650

(22) Filed: Sep. 8, 2025

Related U.S. Application Data
(63) Continuation of application No. PCT/US2024/019215, filed on Mar. 8, 2024.
(60) Provisional application No. 63/489,236, filed on Mar. 9, 2023.

(51) Int. Cl. G06F 21/60; G06F 9/48

(52) U.S. Cl. CPC G06F 21/606; G06F 9/4812; G06F 21/602

(57) ABSTRACT

A non-transitory, processor-readable medium stores instructions to cause a processor to receive an address of an autonomous program and an identifier of a cryptographic data segment. The instructions further cause the processor to generate, based on the address of the autonomous program and the identifier of the cryptographic data segment, a first serialized message configured to call an interrupt function defined by the autonomous program to cause the identifier of the cryptographic data segment to be included in a register. The processor further generates, based on an address of a second user, a second serialized message configured to call a release function defined by the autonomous program to cause removal of the identifier of the cryptographic data segment from the register. In response to generating the second serialized message, the processor generates a third serialized message configured to cause the cryptographic data segment to be possessed by the second user.

### CROSS-REFERENCE TO RELATED APPLICATION

This application is a continuation of PCT Application No. PCT/US24/19215 filed Mar. 8, 2024, and titled “Methods and Apparatus for Secure Transfer of Cryptographic Data Segments,” which claims priority to and the benefit of U.S. Provisional Patent Application No. 63/489,236, filed Mar. 9, 2023, and titled “Methods and Apparatus for Smart Contracting Platform to Reduce Fraud in Non-Fungible Tokens,” the content of each of which is incorporated herein by reference in its entirety.

### FIELD

The present disclosure generally relates to the secure transfer of cryptographic data segments using autonomous programs and a distributed network.

### BACKGROUND

In the field of distributed ledgers, tokens were designed with innate cryptographically provable ownership. However, certain old and new challenges associated with rights and ownership of tokens have remained unsolved. Tokens are frequently used in transactions with anonymous parties in unknown jurisdictions, confounding conventional dispute resolution systems. With tokens disconnected from verifiable binding agreements between such token senders and recipients, often token issuers can only propose one-size-fits-all unilateral terms and conditions (“T&C”). Lastly, decisions on token ownership are frequently unenforceable with existing processes.

Accordingly, a need exists for a new interface with new data structures to tie tokens to data and systems for dispute resolution, such as records of binding agreements between transacting parties, dispute resolution mechanisms, and decision enforcement mechanisms including token transfers.

### SUMMARY

In an embodiment, a non-transitory, processor-readable medium stores instructions to cause a processor to receive (1) an address of an autonomous program deployed on a distributed network and (2) an identifier of a cryptographic data segment (a) deployed on the distributed network and (b) previously transferred from a first user to a second user. The instructions further cause the processor to generate, based on the address of the autonomous program and the identifier of the cryptographic data segment, a first serialized message configured to call an interrupt function defined by the autonomous program to cause the identifier of the cryptographic data segment to be included in a register included in the autonomous program. The processor further generates, based on an address of a second user received at the processor, a second serialized message configured to call a release function defined by the autonomous program to cause removal of the identifier of the cryptographic data segment from the register. In response to generating the second serialized message, the instructions cause the processor to generate a third serialized message configured to call a transfer function defined by the autonomous program to cause the cryptographic data segment to be possessed by the second user.

In an embodiment, a non-transitory, processor-readable medium stores instructions to cause a processor to (1) receive, from a first client compute device, input data and (2) generate, based on the input data, an autonomous program and a function caller associated with the autonomous program. The instructions further cause the processor to (1) deploy the autonomous program on a distributed network and (2) receive, from a second client compute device, a breach indication. Based on the breach indication, the processor causes a message to be sent to the autonomous program. The message is configured to cause the autonomous program to generate an interrupt function call to include an identifier in a register. The instructions also cause the processor to prevent, based on the identifier being included in the register, a cryptographic data segment (1) associated with the identifier, (2) stored on the distributed network, and (3) previously transferred from a first user associated with a third client compute device to a second user associated with a fourth client compute device, from being transferred by the second user.

In an embodiment, a non-transitory, processor-readable medium stores instructions to cause a processor to generate a cryptographic data segment for a first user. The cryptographic data segment includes a plurality of components including (1) an action register, (2) a disabler, and (3) a forced transferer. The instructions also cause the processor to display, to a second user compute device operated by a second user, a requested action associated with the cryptographic data segment to be completed by the second user using a public key of the second user. Additionally, the instructions cause the processor to record a completion of the requested action by the second user, via the action register, to enable a transfer of the cryptographic data segment from a user compute device operated by the first user to the user compute device operated by the second user. From the user compute device operated by the first user, a claim is received at the processor based on the transfer of the cryptographic data segment to the user compute device operated by the second user, the claim triggering a resolver. The instructions also cause the processor to automatically disable, based on the claim, the cryptographic data segment, via the resolver, by triggering the disabler of the cryptographic data segment, to facilitate resolving the claim. In response to an insecure transfer determination by the resolver, the instructions cause the processor to return the cryptographic data segment to the user compute device operated by the first user via the forced transferer.

### BRIEF DESCRIPTION OF THE DRAWINGS

FIG. 1 is a block diagram illustrating a system configured to facilitate the secure transfer of cryptographic data segments, according to an embodiment.

FIG. 2 is a block diagram illustrating a system configured to facilitate the secure transfer of cryptographic data segments, according to another embodiment.

FIG. 3 is a schematic diagram illustrating a distributed ledger system for use in a system configured to facilitate the secure transfer of cryptographic data segments, according to another embodiment.

FIG. 4 is a flow diagram of a method implemented by a system configured to facilitate the secure transfer of cryptographic data segments, according to another embodiment.

FIG. 5 is a flow diagram of a method implemented by a system configured to facilitate the secure transfer of cryptographic data segments, according to another embodiment.

FIG. 6 is a block diagram illustrating a user interface for interacting with tokens, according to another embodiment.

FIG. 7 is a block diagram illustrating a system configured to facilitate the secure transfer of cryptographic data segments, according to another embodiment.

FIG. 8 is a signal diagram illustrating interactions implemented by a system configured to facilitate the secure transfer of cryptographic data segments, according to another.

FIG. 9 is a flow diagram illustrating a method implemented by a system configured to facilitate the secure transfer of cryptographic data segments, according to another embodiment.

FIG. 10 is a flow diagram illustrating a method implemented by a system configured to facilitate the secure transfer of cryptographic data segments, according to another embodiment.

FIG. 11 is a flow diagram illustrating a method implemented by a system configured to facilitate the secure transfer of cryptographic data segments, according to another embodiment.

### DETAILED DESCRIPTION

Some known systems and methods do not facilitate corrective action (e.g., a transaction freeze, reversal, and/or the like) to ensure the secure transfer of a data segment (e.g., a token, such as a non-fungible token, cryptocurrency, fiat money, and/or the like). For example, obtaining a judgment or decision against a counterparty (which can be, for example, an anonymous entity and/or an entity in an unknown foreign jurisdiction) accused of theft and/or illicit use of a token can be an impractical proposition. Current court systems, arbitrators, and other dispute resolution mechanisms are not well-equipped to deal with such cases, and the time and expense involved means only tokens of the highest value would be worth litigating over. Moreover, even if a judgment or decision is somehow obtained against the counterparty, freezing or recovering a token is difficult or impossible. Such limitations originate from technical capabilities that current tokens and token management interfaces currently lack. To establish enforceability of judgments and/or decisions, such that recovery of a data segment can be improved, a modified type of data segment (e.g., token) and data segment management system can be used.

In some embodiments, a system can include a dispute resolver (herein “DR”), a token (or any other data segment) with integrated dispute resolution (herein “T-IDR”), a gatekeeper application (herein “gatekeeper app”), and a set of conditions and/or criteria, such as a dispute resolving smart contract (herein “DR-SC”). Each of the foregoing components can be linked to one another on a distributed ledger. In some implementations, the DR-SC can be an autonomous program (e.g., a program that can execute without human intervention), such as a smart contract integrated with a decentralized autonomous organization (DAO). In some implementations, an autonomous program can include an application configured to use a cryptographic data structure (e.g., a verifiable credential) to, for example, verify a credential. In some instances, the T-IDR can include a token and/or other signed and/or encrypted data structures, such as W3C Verifiable Credentials/Presentations, W3C Decentralized Identifiers (DIDs), JWTs, 1EdTech Open Badges, etc.

In some embodiments, a compute device can generate a gatekeeper app by using, for example, a DR, which can include software and/or hardware components, as described herein. For example, in some implementations, the DR can include an application executed by a compute device. The gatekeeper app can be a decentralized application, a conventional software application, and/or a program, deployed and/or executed by the compute device. The gatekeeper app can ensure that T-IDR transactions are subject to cryptographically verifiable binding agreements and other actions to form a sufficiently transparent relationship between parties. The DR can provide dispute resolution bodies with secure (e.g., unfalsifiable) records used to adjudicate disputes, even if parties are anonymous. The DR can be given capabilities to enforce judgments/decisions programmatically, including freezing/unfreezing and returning T-IDRs.

In some implementations, T-IDRs that drastically reduce cost and complexity of arbitration while radically improving enforceability could be as transformative for certain other assets, including physical assets. Tokenizing other assets as T-IDRs can bring access to swift and reliable arbitration to small business and individuals.

In some embodiments, an apparatus can include a system for tokens such as non-fungible/semi-fungible tokens (NFTs) with integrated dispute resolution (T-IDR). T-IDRs are generated by T-IDR smart contracts (T-IDR-SC) in a similar manner that tokens can be generated by token smart contracts. In some implementations, the T-IDR-SC can be an application configured to execute on a compute device. The T-IDR-SC can generate T-IDRs that can be frozen or forcibly transferred by smart contracts. In some implementations, a DR can generate and/or deploy a DR-SC and a gatekeeper app, where the T-IDRs can be restricted by the gatekeeper app. The gatekeeper app can also keep a record of T-IDR transactions and provide the T-IDR transactions to the DR or DR-SC. In some implementations, the gatekeeper app can be called by a plurality of compute devices and/or DRs. In some implementations, during a dispute, components of the T-IDR-SC can be called by the DR (e.g., via the DR-SC), causing an on-chain computation in a distributed ledger network.

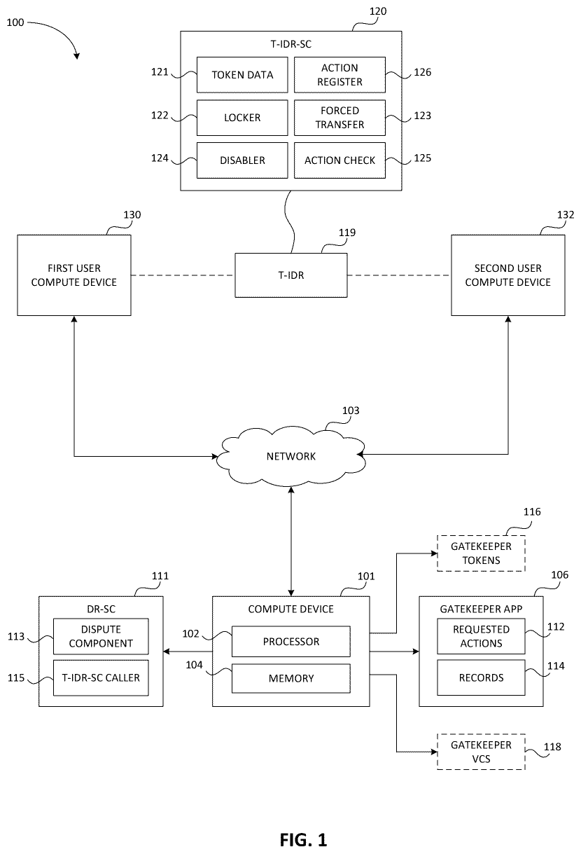

In some implementations, the DR can freeze or forcibly transfer T-IDRs using records originally provided by the gatekeeper app, as described herein. In some cases, the gatekeeper app can require a user to take requested actions before acquiring a T-IDR, as described herein. In some implementations, the gatekeeper app can generate or use one or both of two types of cryptographically-enabled records that are suitable for the gatekeeper app's functionality: a gatekeeper token (e.g., an NFT used as a digital credential or record by a T-IDR-SC or gatekeeper app) and/or a gatekeeper Verified Credential (VC) (e.g., a W3C Verifiable Credential or derived Verifiable Presentation used as a digital credential or record by a T-IDR-SC or gatekeeper app). For instance, a gatekeeper token can be associated with a smart contract (e.g., T-IDR-SC 120 of FIG. 1, described herein) and natively on-chain of the distributed ledger network.

Additionally, gatekeeper VCs (e.g., gatekeeper VCs 118 of FIG. 1, described herein) can be verifiable credentials (e.g., a W3C Verifiable Credential) for a user such that the gatekeeper VCs are mature (having a robust library), robust, and/or versatile forms of digital representations of real-world credentials (e.g., diplomas, licenses, certifications, etc.) that are cryptographically signed such that the gatekeeper VCs can be easily shared and/or be used to verify the user. In some implementations, the gatekeeper VCs can have delineated structures such that different users can understand and/or interpret the gatekeeper VCs while reducing the risk of errors and improve the speed and reliability of a verification process of the gatekeeper VCs. In some implementations, the gatekeeper VCs can also include related standards such as, for example, decentralized identifiers (DIDs) and verifiable presentations.

In some implementations, the gatekeeper tokens (e.g., gatekeeper tokens 116 of FIG. 1, described herein) and the gatekeeper VCs can be and/or include a form of digital credential. For instance, an operator of a T-IDR-SC can include a condition that enables only United States citizens to receive T-IDRs. The operator of the T-IDR-SC can thus verify digital passports of users in the form of a gatekeeper token and/or a gatekeeper VC. In some implementations, the gatekeeper tokens, T-IDRs, and/or the gatekeeper apps are based on smart contracts and are natively on-chain via the distributed ledger. In some cases, gatekeeper VCs can be used with the gatekeeper app, acting as digital credentials to satisfy any required actions administered by the gatekeeper app. In some implementations, the gatekeeper app can generate the gatekeeper token using, for example, ERC-721 and/or ERC-1155 standards. In some implementations, the gatekeeper VC can be or include, for example, a World Wide Web Consortium (W3C) Verifiable Credential and/or Verifiable Presentation.

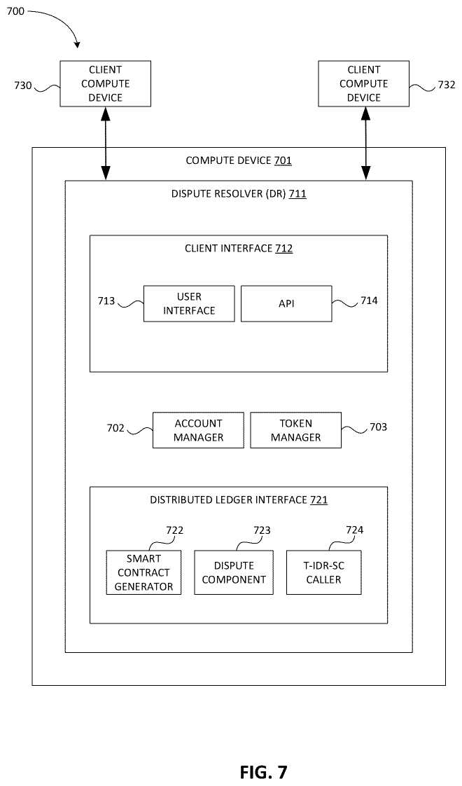

In some implementations, the gatekeeper token and/or the gatekeeper VC can be held by a user, enabling and/or authorizing a user to acquire a T-IDR. In some cases, the user can already own a gatekeeper token and/or the gatekeeper VC, representing, for example, a driver's license, a diploma, a certificate, and/or the like. In some cases, the user does not own a gatekeeper token and/or a gatekeeper VC, in which case the gatekeeper app can generate a gatekeeper token and/or a gatekeeper VC for the user (or facilitate the generating of the gatekeeper token and/or the gatekeeper VC). In some implementations, the gatekeeper token and/or the gatekeeper VC can perform at least one similar function as the gatekeeper app. For instance, the gatekeeper app can require and/or request qualifications from a user and/or require and/or request the user to take certain actions (e.g., providing credentials, signing an agreement, providing authorization, providing cryptographically verifiable data, etc.) and present or transmit a record of a completion of the certain actions to the T-IDR-SC. In some implementations (e.g., as shown at least in FIG. 7), the gatekeeper app is not used for the DR to interact with the T-IDR (e.g., to cause the freezing of the T-IDR, a forced transfer, etc.). In some implementations, the gatekeeper token and/or the gatekeeper VC can be used to satisfy certain actions and/or qualifications from the gatekeeper app. For instance, the gatekeeper token and/or the gatekeeper VC can represent a driver's license identifying a holder of that driver's license if the qualifications from the gatekeeper app require identification.

To generate a gatekeeper token, a token smart contract can be written (e.g., using Solidity, Vyper, etc.) to be conformant with a smart contract standard (e.g., ERC-721, ERC-1155, ERC-3525, ERC-5516, etc.). The token smart contract can be compiled into bytecode (e.g., using Remix, Truffle, Hardhat, etc.), and a signed transaction (e.g., a message signed with an Elliptic Curve Digital Signature Algorithm (ECDSA) and/or the like) can be sent to deploy the token smart contract. Following this deployment, the gatekeeper token can be generated by calling the token smart contract's minting function (e.g., “mint” and/or “safeMint,” if the ERC721Mintable extension is used) using another signed (e.g., with ECDSA) transaction. When the gatekeeper token is generated, the gatekeeper token can include structured data representing a token holder's (e.g., a recipient's) qualifications to receive the T-IDR.

To generate a gatekeeper VC, data associated with, for example, the W3C Verifiable Credential standard can be combined with arbitrary data representing the token holder's qualifications to receive the T-IDR. This data can then be formatted as, for example, JSON-LD, JWT, CBOR, XML, and/or the like. The gatekeeper app and/or the subject of the VC can generate an SHA hash of the VC data, and then use a private key to generate a signature (e.g., based on a Rivest-Shamir-Adleman (RSA) algorithm, ECDSA, Edwards-curve Digital Signature Algorithm (EdDSA), etc.) from the hash. The signature can be placed in a proof field of the VC, and the VC can be uploaded to a destination (e.g., a memory) accessible by the gatekeeper app. The destination can include the distributed ledger or, to improve memory usage, a dedicated decentralized memory (e.g., a memory associated with InterPlanetary File System (IPFS)) or a conventional storage memory (e.g., a memory associated with a cloud server, local server, etc.).

FIG. 1 is a block diagram of a system 100 for a smart contracting platform to perform data transfers and/or reduce fraud associated with data segments (e.g., tokens, non-fungible tokens, etc.), according to an embodiment. The system 100 can include a compute device 101, a first user compute device 130 operated by a first user, and a second user compute device 132 operated by a second user. The first user and the second user can be, for example, parties to a transaction (e.g., between the first user and the second user), a smart contract, and/or the like. For example, the first user operating the first user compute device 130 can own a T-IDR 119. Later, the T-IDR 119 can be transferred to a second user operating the second user compute device 132 seeking to acquire the T-IDR 119 and its accompanying rights and/or as a result of a transaction (e.g., an autonomous transaction caused by a smart contract. As described herein, the system 100 can be configured to pause, verify, and/or block the transfer to prevent fraud and/or ensure the secure and/or correct transfer of the data segment.

In some embodiments (e.g., different than that shown in FIG. 1), a system that is functionally similar to the system 100 can include, for example, a dispute resolver (DR). For example, an embodiment that includes a DR system 700 is described further herein in relation to FIG. 7.

The system 100 can also include a dispute resolving smart contract (DR-SC) 111 and a gatekeeper app 106. In some implementations, the DR-SC 111 can include a smart contract. In some embodiments, DR-SC 111 can be deployed and/or defined by, for example, a DR (e.g., a DR functionally and/or structurally equivalent to the DR 711 of FIG. 7, described herein) and/or an operator of the DR. In some cases, the compute device 101 can be configured to generate and/or deploy the DR-SC 111, the gatekeeper app 106, and/or an integrated dispute resolution smart contract (T-IDR-SC) 120. In some cases, deploying the T-IDR-SC 120 and/or the DR-SC 111 can include, for example, uploading the T-IDR-SC 120 and/or the DR-SC 111 to a distributed ledger network (not shown in FIG. 1) to enable the T-IDR-SC 120 and/or the DR-SC 111 for execution (or self-execution) once approved by a group of computing nodes in the distributed ledger network. The group of computing nodes in the distributed ledger network can enable the T-IDR-SC 120, including the T-IDR (or transaction of), to be recorded on a distributed ledger of the distributed ledger network. Each computing node can store a copy of the distributed ledger. The gatekeeper app 106 can be, for example, a software application that is generated and/or deployed on some network (e.g., a network 103) that can be accessed by the first user compute device 130 and the second user compute device 132.

The system 100 can also include a network 103 via which the compute device 101, the first user compute device 130, and the second user compute device 132 can communicate to each other.

The compute device 101 can include a processor 102 and a memory 104 that communicate with each other, and with other components, via a bus (not shown). The bus can include any of several types of bus structures including, but not limited to, a memory bus, a memory controller, a peripheral bus, a local bus, and any combinations thereof, using any of a variety of bus architectures. The compute device 101 can include, for example, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. The compute device 101 can also include multiple compute devices that can be used to implement a specially configured set of instructions for causing one or more of the devices to perform any one or more of the aspects and/or methodologies of the present disclosure.

The compute device 101 can include a network interface device (not shown in FIG. 1). The network interface device can be used to connect the compute device 101 to one or more of a variety of networks (e.g., the network 103) and one or more remote devices connected thereto. Examples of a network interface device include, but are not limited to, a network interface card (e.g., a mobile network interface card, a LAN card, etc.), a modem, and any combination thereof. Examples of a network can include a wide area network (e.g., the Internet, an enterprise network, etc.), a local area network (e.g., a network associated with an office, a building, a campus or other relatively small geographic space, etc.), a telephone network, a data network associated with a telephone/voice provider (e.g., a mobile communications provider data and/or voice network, etc.), a direct connection between two computing devices, and/or the like. The compute device 101 can employ a wired and/or a wireless mode of communication.

The processor 102 can be or include, for example, a hardware based integrated circuit (IC), or any other suitable processing device configured to run and/or execute a set of instructions or code. For example, the processor 102 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor 102 can be configured to run any of the methods and/or portions of methods discussed herein.

The memory 104 can be or include, for example, a random-access memory (RAM), a memory buffer, a hard drive, a read-only memory (ROM), an erasable programmable read-only memory (EPROM), and/or the like. In some instances, the memory 104 can store, for example, one or more software programs and/or code that can include instructions to cause the processor 102 to perform one or more processes, functions, and/or the like. In some implementations, the memory 104 can include extendable storage units that can be added and used incrementally. In some implementations, the memory 104 can be a portable memory (e.g., a flash drive, a portable hard disk, and/or the like) that can be operatively coupled to the processor 102. In some instances, the memory 104 can be remotely operatively coupled with a compute device (not shown); for example, a remote database device can serve as a memory and be operatively coupled to the compute device. The memory 104 can include various components (e.g., machine-readable media) including, but not limited to, a random-access memory component, a read-only component, and any combinations thereof. In one example, a basic input/output system (BIOS), including basic routines that help to transfer information between elements within the compute device 101, such as during start-up, can be stored in memory 104. The memory 104 can further include any number of program modules including, for example, an operating system, one or more application programs, other program modules, program data, and any combinations thereof.

The memory 104 can include instructions to cause the processor 102 of to generate a T-IDR-SC 120. The T-IDR-SC 120 can be configured to implement (e.g., generate) a T-IDR 119, which, as described herein, can be a data segment (e.g., a token) having integrated dispute resolution functionality. In some implementations, the T-IDR-SC 120 can be associated with, for example, an extension of the ERC-721 or ERC-1155 standards, their respective derivatives on Ethereum virtual machine (EVM) compatible networks, etc. In some implementations, the T-IDR-SC 120 can be an extension of standards for non-fungible or semi-fungible tokens on Solana-compatible networks, Bitcoin network forks that implement non-fungible or semi-fungible tokens, and/or the like.

The DR-SC 111 can be or include a smart contract configured to resolve disputes between transfers of T-IDRs between users. In some implementations, the DR-SC 111 and/or the T-IDR-SC 120 can include components that can be called and/or acted upon on an EVM-compatible (or similar) public distributed ledger such as, for example, an EVM blockchain. In some implementations, the distributed ledger can support non-fungible tokens, fungible tokens, and/or semi-fungible tokens. The distributed ledger can be associated with a distributed ledger network that includes computing nodes. In some implementations, the computing nodes can be or include EVMs and/or the like.

The T-IDR-SC 120 can be set, managed, and/or maintained by an operator of the T-IDR-SC 120. In some cases, the operator of the T-IDR-SC 120 can be an operator of the compute device 101 (or, as described herein at least in relation to FIG. 7, a DR 711, as described herein). In some implementations, an operator can be an entity such as, for example, a human or another smart contract. In some implementations, the operator of the compute device 101 can be an entity that deployed and/or defined the T-IDR-SC 120, the DR-SC 111, and/or the gatekeeper app 106. In some cases, the compute device 101, the T-IDR-SC 120, the DR-SC 11, and/or the gatekeeper app 106 can be operated by the same operator.

In some implementations, the T-IDR-SC 120, as a result of being executed by a compute device (e.g., the compute device 101) and/or a compute node associated with a distributed network, can implement, mint, and/or enable a minting of a T-IDR 119 on that distributed network. For example, the T-IDR-SC 120 can enable a minting process and/or creation of the T-IDR 119. The T-IDR-SC 120 can also assign an owner to the T-IDR 119. The T-IDR-SC 120 can also enable the transfer of the T-IDR 119 to a new owner (e.g., transferring the T-IDR 119 from the first user operating the first user compute device 130 to the second user operating the second user compute device 132). The T-IDR-SC 120 can include a token identifier (ID) for the T-IDR 119. The T-IDR-SC 120 can include multiple components that can be executed by a compute device (e.g., the compute device 101) and/or a compute node associated with a distributed network, to perform various actions. In some implementations, the multiple components of the T-IDR-SC 120 can be executed and/or called automatically. The components can include a token data component 121, a locker component 122 (also referred to as a “locker”), a disabler component 124 (also referred to as a “disabler”), an action register 126, a forced transfer component 123 (also referred to as a “forced transferer”), and an action check component 125 (also referred to as an “action checker”). In some implementations, a T-IDR-SC caller 115 of the DR-SC 111 can include callers of components in the T-IDR-SC 120 such that a component of the DR-SC 111 can call a corresponding component of the T-IDR-SC 120 (e.g., token data component 121, locker component 122, disabler component 124, action register 126, forced transfer component 123, action check component 125, and/or the like). For example, the DR-SC 111 can use T-IDR-SC caller 115 to call the disabler component 124 of the T-IDR-SC 120 by calling a corresponding disabler component of the T-IDR-SC caller 115. As a result, the DR-SC 111 can control the ownership of the T-IDR 119.

The token data component 121 can include data such as, for example, addresses of DR-SCs linked to the T-IDR 119, gatekeeper apps (e.g., gatekeeper app 106) linked to the T-IDR, addresses of linked gatekeeper apps, properties of gatekeeper apps, metadata of the T-IDR 110, (e.g., ERC-721 or ERC-1155 Metadata JSON, any associated metadata URIs, etc.), and/or the like.

The disabler component 124 can be callable by the DR-SC 111 via a corresponding disabler component in the T-IDR-SC caller 115. In some cases, the disabler component 124 can be initiated by a call to the DR-SC 111 from a previous owner of the T-IDR 119, such as the first user operating the first user compute device 130 after the T-IDR 119 has been transferred to the second user operating the second user compute device 132. For instance, after a transfer of the T-IDR 119 from the first user compute device 130 to the second user compute device 132, the first user compute device 130 can submit a dispute claim. The dispute claim can be or include any claim to freeze the T-IDR 119 that was transferred due to reasons such as, for example, an occurrence of a fraud related to the transfer of the T-IDR 119, a breach of contract/agreement, lack of proper identification, and/or the like.

The disabler component 124 can disable the T-IDR-SC's 120 transferFrom/safeTransferFrom functions for the T-IDR 119, using the token identifier of the T-IDR 119 in some implementations. This is so, at least in part, to enable freezing of the T-IDR 119 during a dispute resolution. The dispute resolution can be, for example, a process to resolve the dispute claim. For instance, a first user operating the first user compute device 130 can accuse a second user operating the second user compute device 132 of a fraudulent acquisition of the T-IDR 119.

In some implementations, the dispute resolution can occur on-chain, such as, for example, on a distributed ledger of a distributed ledger network (not shown in FIG. 1). For instance, the dispute resolution for the T-IDR 119 can occur at the distributed ledger network. In some cases, the distributed ledger network can be, for example, a network of compute nodes that use distributed ledger technology to maintain a shared, synchronized record of transactions (e.g., transfer of T-IDRs). The distributed ledger network can enable multiple compute nodes to access and verify records of transactions. In some cases, the distributed ledger network, can be, for example, a blockchain network of compute nodes that maintain and verify a shared digital ledger (e.g., copy of the distributed ledger) of transactions using cryptographic algorithms. In some implementations, the compute device 101, the first user compute device 130, and/or the second user compute device 132, can be or include a computing node from a group of computing nodes associated with the distributed ledger network. At least one computing node from this group of computing nodes associated with the distributed ledger network can execute (e.g., via a processor(s)) the DR-SC 111 (and/or components therein) and/or the T-IDR-SC 120 (and/or components therein).

The forced transfer component 123 can be called, for example, by the DR or DR-SC 111 through T-IDR-SC caller 115 (or directly by the T-IDR-SC 120), for example, from a device in the distributed ledger network, to forcibly transfer the T-IDR 119 from one user to another user in order to, for example, effect a dispute resolution decision reached by the operator of the DR or DR-SC 111. In some implementations, the forced transfer component 123 capability can be enabled by setting a T-IDR-SC's isApprovedForAll flag to be true for the address of the DR-SC 111 or an address associated with the DR.

The locker component 122 can be initialized by the operator of the T-IDR-SC 120 or, where authorized by the operator of the T-IDR-SC 120, by a holder of the T-IDR 119 (e.g., the first user operating the first user compute device 130). For instance, after the T-IDR 119 is transferred to the second user compute device 132 operated by the second user, a lock-up period begins, disabling, for a predefined time period (e.g., as specified by the first user), the T-IDR-SC's 120 transferFrom and safeTransferFrom functions for the T-IDR 119. This, at least in part, can prevent fencing/laundering of the T-IDR 119. The lock-up period can default to 0 (corresponding to default token behavior) and can be measured in either blocks or standard time units such as seconds, hours, and days (facilitated by, for example, an Ethereum Alarm Clock TimeNode smart contract).

In some cases, the action register 126 can be called, by the gatekeeper app 106, to receive, validate, and/or store cryptographically verifiable data used to record actions 112 (or at least one action) taken by the second user (e.g., using second user compute device 132) using an address associated with the second user (e.g., an EVM blockchain address/account). The action register 126 can be called to request cryptographically verifiable data from the first user and/or the second user prior to the transfer of the T-IDR 119 from the first user compute device 130 to the second user compute device 132. In some cases, the cryptographically verifiable data can also be verified by the DR or DR-SC 111 during a dispute resolution process. In some instances, cryptographically verifiable data can be, for example, any standard data structure for any Web3 Provider (e.g., digital wallets) such as EIP-712 Typed Structured Data, a Verifiable Presentation, a JSON Web Token, and/or the like. The cryptographically verifiable data can include, for example any records of requested actions 112 taken, information validating a user, and/or the like. In some implementations, when the action register 126 is called, following actions can be performed on the distributed ledger network and stored in the memory of the T-IDR-SC 120. In some implementations, the requested actions 112 can be, for example, a signature, contract, consent, legal agreement, and/or a know your customer (KYC) process.

Where the cryptographically verifiable data includes, for example, EIP-712 typed structured data, to verify such data, the data can be hashed using, for example, a Keccak-256 cryptographic function, and ECDSA (and/or the like) can then be used to sign and/or validate the data. Where the cryptographically verifiable data includes, for example, W3C verifiable presentations and/or JSON web tokens, a secure hashing algorithm (SHA) can be used for hashing; RSA, ECDSA, EdDSA, and/or the like, can be used for signing/validation; and JSON Web Signatures (JWS), Linked Data Proofs, and/or Zero-Knowledge Proofs (e.g., zk-SNARKs), can used as proof data structures.

The action check component 125 can be called to check if a prospective recipient of a T-IDR 119 owns an address qualified, possibly by data in the action register 126, to receive the T-IDR 119. For instance, the T-IDR-SC's 120 transferFrom/safeTransferFrom functions can be modified to call action check component 125 to check if the address of the second user operating the second user compute device 132 completed the requested actions 112 as denoted by the gatekeeper app 106 to receive the T-IDR 119. The _to and _tokenId arguments of the transferFrom/safeTransferFrom functions can be sufficient to determine which actions to check. The action check component 125 can also return data on the action if found, otherwise it can return false.

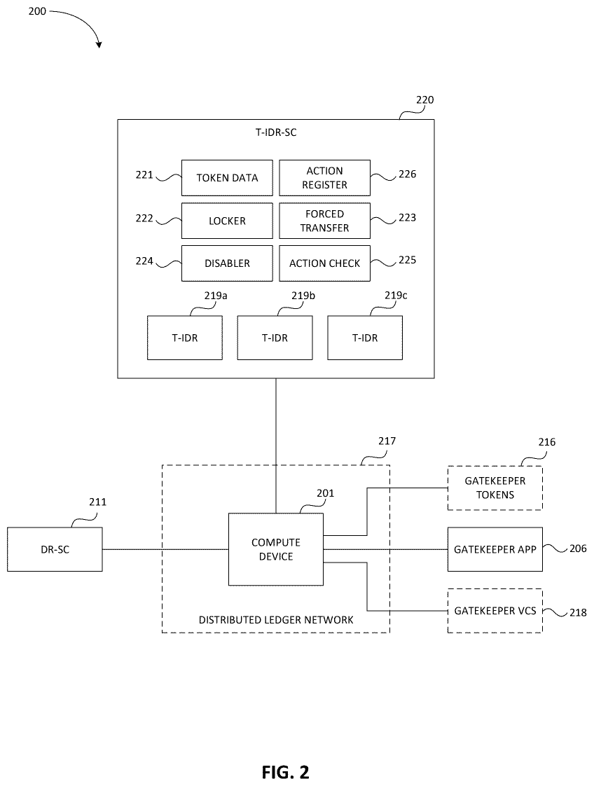

In some implementations, the action register 126 can be stored longer (e.g., in permanent storage) than the records 114 (described herein). To conserve memory, the action register 126 can include a compressed representation of the records 114. Compression of the action register 126 can be performed using, for example, a GZIP or similarly suited method. In some implementations, the action register 126 can include a cryptographic representation of the records 114, such as a hash (e.g., associated with SHA and/or the like) and/or a cryptographic signature (e.g., associated with RSA, ECDSA, EdDSA, and/or the like). The records 114 and/or the action register 126 can be stored on a distributed ledger (e.g., (1) within T-IDR-SC, as shown in FIGS. 1 and 2, and/or (2) elsewhere on the ledger). Alternatively, or in addition, the records 114 and/or the action register 126 can be stored in decentralized storage (e.g., associated with IPFS and/or the like) and/or in conventional storage (e.g., a cloud server, local server, and/or the like).

The DR-SC 111 can include one or more components (e.g., software components) configured to be executed, such as, for example, a dispute component 113. Through the T-IDR-SC caller 115, the dispute component 113 can call the disabler component 124 and the action check component 125 of the T-IDR-SC 120. The disabler component 124 can cause a freeze of a transfer of the T-IDR 119. The dispute component 113 can pass a result of the action check component 125 and/or any other data used to initiate and resolve a dispute claim sent to the DR. In some cases, the dispute component 113 is callable using a signed transaction from an address that previously held a T-IDR 119 (e.g., an EVM blockchain address of the first user operating the first user compute device 130) for which the DR or DR-SC 111 currently has permission to trigger the disabler component 124 and the forced transfer component 123 of the T-IDR-SC 120. The signed transaction's payload can contain the token identifier of the T-IDR 119 that is disputed and an address of the T-IDR-SC 120 (e.g., an Ethereum address).

The DR-SC 111 can also call the T-IDR-SC caller 115 to call the action check component 125, to recover any records 114 (e.g., at least one record) used to resolve a dispute of the T-IDR 119. The records 114 (or at least one record) can include information about any signed transactions, address of previous and/or current owners of the T-IDR 119, and/or the like. In some cases, the records 114 can be stored in the DR to simplify retrieval of the records 114 to resolve the dispute.

The compute device 101 or the DR can also optionally generate gatekeeper VCs 118 (a W3C Verifiable Credential or derived Verifiable Presentation) and/or gatekeeper tokens 116. In some implementations, the gatekeeper VCs 118 and/or the gatekeeper tokens 116 can be an extension of the gatekeeper app 106. The gatekeeper app 106 can generate and/or implement requested actions 112 to be completed by users involved in the transfer of the T-IDR 119 where a record of completion (or incompletion) of the requested actions 112 of the gatekeeper app 106 for the second user operating the second user compute device 132 (or any recipient of the T-IDR 119). In some cases, the gatekeeper app 106 can include records 114 of completion (or incompletion) of the requested actions 112. The records 114 can be used by the DR-SC 111 and/or the DR to verify that the requested actions 112 were completed with accurate information. The records 114 can be stored on the distributed ledger of the distributed ledger network.

In some implementations, gatekeeper tokens 116 and/or gatekeeper VCs 118 can be owned and/or held by a user attempting to acquire the T-IDR 119. In some cases, the acquirer can already have a gatekeeper token and/or a gatekeeper VC (e.g., a diploma or driver's license represented as a VC or NFT). In some cases, the gatekeeper app 106 can facilitate the obtaining of the gatekeeper tokens 116 and/or the gatekeeper VCs for users. In some cases, the gatekeeper tokens 116 and/or gatekeeper VCs 118 can perform some similar functions as a digital credential. In some implementations, the gatekeeper app 106 can verify gatekeeper VCs 118. In some implementations, records of gatekeeper tokens 116 and/or gatekeeper VCs 118 can be used to satisfy requirements specified in the token data component 121 (or the requested actions 112 from the gatekeeper app 106) which can be looked up on a distributed ledger of the distributed ledger network in response to an execution of the action check component 125. In some instances, a user (e.g., the second user) operating the second user compute device 132 can provide a verifiable record of a gatekeeper token and/or a gatekeeper VC to the T-IDR-SC 120 (or operator of the T-IDR-SC 120, or owner of the T-IDR 119 to be acquired) directly, or indirectly via a separate gatekeeper app 106, to satisfy requirements specified in the token data component 121 (or the requested actions 112 from the gatekeeper app 106) to acquire the T-IDR 119 from the first user operating the first user compute device 130. For example, the gatekeeper token and/or the gatekeeper VC of the second user compute device 132 can include addresses and/or token IDs to satisfy requirements specified by the token data component 121 (or the requested actions 112 from the gatekeeper app 106) to enable a register of the requested actions 112 in response to a successful completion of the requirements specified by the token data component 121 (or the requested actions 112 from the gatekeeper app 106). The first user operating the first user compute device 130 can also provide a gatekeeper token and/or a gatekeeper VC to satisfy requirements specified by the token data component 121 (or the requested actions 112 from the gatekeeper app 106) such as, for example, identifying the first user as a sender (or current owner) of the T-IDR 119. In some implementations, the gatekeeper app 106 can force a user (e.g., the second user) to take certain actions before acquiring the T-IDR 119, then transmit records 114 of the requested actions 112 to the T-IDR-SC 120.

For the transfer of the T-IDR 119 from the first user to the second user to occur, requested actions 112 can be conducted for completion by the second user. For example, the requested actions 112 can include asking the second user to use an EVM-compatible blockchain address to digitally sign terms and conditions (T&C) provided by the gatekeeper app 106. This can create and/or define a verifiable contractual relationship between the first user, the second user, and the DR operator, even if one or more entities (e.g., the first/second user and/or the DR operator) are anonymous. The gatekeeper app 106 can pass and/or send records 114 of a completion of the requested actions 112 such as, for example, a signature, to the T-IDR-SC 120. The T-IDR-SC 120 can store the records 114 on a distributed ledger of the distributed ledger network, enabling the records 114 to be used for both restricting access to the T-IDR 119 and for a dispute resolution process. The dispute resolution process can be used for any dispute claims involving the T-IDR 119 and any recipient and sender associated with the T-IDR 119.

In some instances, the second user can view metadata of the T-IDR 119 using, for example, an online and/or digital marketplace. The second user can view the requested actions 112 to acquire the T-IDR 119 such as, for example, instructions in the metadata of the T-IDR 119 mandated by the T-IDR-SC 120. Such metadata can include, for example, human-readable text that can permit the second user to know any actions to perform to acquire the T-IDR 119 (e.g., if the T-IDR 119 is being offered on a marketplace, such as OpenSea and/or the like). As a further example, the T-IDR 119 can be an ERC-721 token, and a ‘description’ field of the ‘ERC721Metadata’ JSON can be used to represent the metadata. In some implementations, the metadata can include machine-readable data. The second user can complete the requested actions 112 which can be registered via an action register 126 of the T-IDR-SC 120, enabling the second user to acquire the T-IDR 119. In some implementations, the transfer of the T-IDR 119 can be automatic. In some cases, further transfers of the T-IDR 119 can be disabled by the T-IDR-SC 120 for a duration of a lock-up period activated by a locker component 122 of the T-IDR-SC 120 to block fencing/laundering of the T-IDR 119, and to provide the sender and/or the recipient of the T-IDR 119 a period of time to broadcast a dispute claim. In addition, in response to receiving a dispute claim, the T-IDR-SC 120 can use disabler component 124 to freeze T-IDR 119. This is so, at least in part, to prevent the T-IDR 119 from being transferred during a dispute resolution process to resolve the dispute claim.

In some cases, the first user can believe that the second user has broken an agreement and/or acquired the T-IDR 119 through some fraudulent and/or dishonest means. The first user can send and/or broadcast a dispute claim by calling a dispute component 113 of the DR-SC 111 using a distributed ledger address, such as an EVM address, associated with the first user. In some cases, the dispute component 113 (or other components) can be called automatically. The DR-SC 111 can automatically freeze the T-IDR 119 through a disabler component 124 of the T-IDR-SC 120 while the dispute resolution process is pending. The dispute resolution process can include checking records 114 to identify if the completed requested actions 112 by the second user are authentic (e.g., using methods described above in relation to cryptographic validation of records). This can be accomplished by calling an action check component 125 of the T-IDR-SC 120. In some cases, the dispute resolution process can include, for example, an arbitration, a DAO dispute resolution process, or another process to resolve the dispute claim. Both the first user and the second user can be instructed to follow the instructions of the DR operator managing the dispute claim during the dispute resolution process.

In some instances, the DR operator can render a decision of the dispute claim from the dispute resolution process. If the second user is not at fault (e.g., the dispute claim is invalid) the T-IDR 119 can be unfrozen by calling the disabler component 124 of the T-IDR-SC 120, restoring normal functionality. If the second user is found at fault (e.g., the dispute claim is valid), the DR-SC 111 can forcibly return the T-IDR 119 back to the first user by calling a forced transfer component 123 of the T-IDR-SC 120.

In another example, instead of deploying the gatekeeper app 106 to facilitate the requested actions 112 for the first user and the second user, the gatekeeper app 106 can generate a gatekeeper token and/or a gatekeeper VC for the first user and/or the second user. For instance, the first user and/or the second user can obtain the gatekeeper token and/or a gatekeeper VC which can be configured as qualifications for the first user and/or the second user. The gatekeeper token and/or a gatekeeper VC can be used to represent requested actions 112 taken by the first user and/or second user to complete and/or to enable a transfer of the T-IDR 119 from the first user to the second user.

FIG. 2 is a block diagram of a system 200 for a smart contracting platform to reduce fraud in non-fungible tokens, according to another embodiment. The system 200 includes a distributed ledger network 217 and a compute device 201. In some implementations, the distributed ledger network 217 can be structurally and/or functionally similar to any suitable distributed ledger network as described herein. The distributed ledger network 217 can include a group of computing nodes (including the compute device 201). In some cases, the group of computing nodes of the distributed ledger network 217 can also include senders and/or recipients of T-IDRs 219a-219c. In some implementations, the compute device 201 can be structurally and/or functionally similar to the compute device 101 previously described in FIG. 1. In some implementations, the compute device 201 can deploy a T-IDR-SC 220, a DR-SC 211, gatekeeper tokens 216, a gatekeeper app 206, and/or gatekeeper VCs 218. The T-IDR-SC 220 can be structurally and/or functionally similar to the T-IDR-SC 120 previously described in FIG. 1. The DR-SC 211 can be structurally and/or functionally similar to the DR-SC 111 previously described in FIG. 1. The gatekeeper tokens 216 can be structurally and/or functionally similar to the gatekeeper tokens 116 previously described in FIG. 1. The gatekeeper app 206 can be structurally and/or functionally similar to the gatekeeper app 106 previously described in FIG. 1. The gatekeeper VCs 218 can be structurally and/or functionally similar to the gatekeeper VCs 118 previously described in FIG. 1. In some implementations, each computing node of the group of computing nodes of the distributed ledger network 217 can facilitate transactions of the T-IDRs 219a-219c and/or the like.

In some implementations, the compute device 201 can be a compute device operating a distributed ledger client, such as, for example, a blockchain node (e.g., computing node). In some cases, the blockchain node can be or include an Avado i7-864 and/or the like. In some implementations, each of the T-IDR-SC 220, the DR-SC 211, the gatekeeper tokens 216, the gatekeeper app 206, and/or the gatekeeper VCs 218 can be stored in a memory of the compute device 201. In some cases, other computing nodes of the distributed ledger network 217 can also store copies of the T-IDR-SC 220, the DR-SC 211, the gatekeeper tokens 216, the gatekeeper app 206, and/or the gatekeeper VCs 218. Each computing node can receive updated copies based on future transactions of T-IDRs 219a-219c.

In some implementations, the T-IDR-SC 220 can implement, mint, and/or enable a minting of multiple T-IDRs 219a-219c. For example, the T-IDR-SC 220 can enable a minting process and/or creation of the T-IDRs 219a-219c. The T-IDR-SC 220 can also assign an owner to the T-IDRs 219a-219c. The T-IDR-SC 220 can also enable the transfer of the T-IDRs 219a-219c to a new owner (e.g., transferring a T-IDR from a first user operating a first user compute device to a second user operating a second user compute device). The T-IDR-SC 220 can include a token identifier (ID) for the T-IDRs 219a-219c. The T-IDR-SC 220 can include multiple components that can be executed to perform various actions. In some implementations, the multiple components of the T-IDR-SC 220 can be executed and/or called automatically (e.g., by the compute device 201 and/or a compute device associated with the distributed ledger network 217). The components can include, for example, a token data component 221, a locker component 222, a disabler component 224, an action register component 226, a forced transfer component 223, and an action check component 225. In some implementations, a T-IDR-SC caller 215 of the DR-SC 211 can include callers of components in the T-IDR-SC 220 such that a component of the DR-SC 211 can call a corresponding component of the T-IDR-SC 220 (e.g., token data component 221, locker component 222, disabler component 224, action register component 226, forced transfer component 223, action check component 225, and/or the like).

In some implementations, a transaction of a T-IDR can involve a first user compute device and a second user compute device, both of which are not part of the group of computing nodes associated with the distributed ledger network 217. As such, each of the first user compute device and the second user compute device can use Remote Procedure Calls (RPCs), application programming interfaces (APIs), and/or other web3 services (e.g., Infura, Alchemy, etc.) to interact with the distributed ledger network 217.

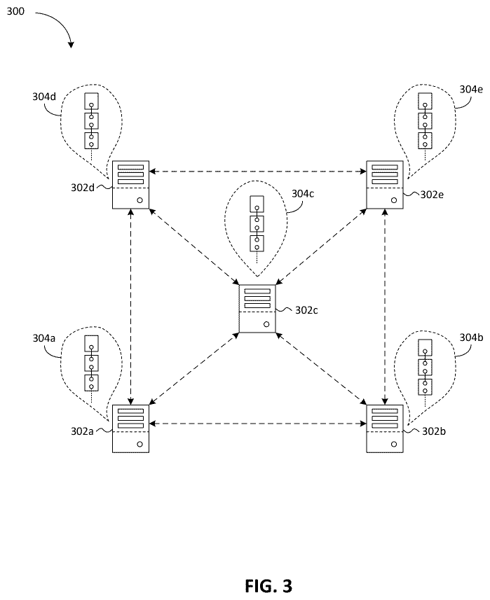

FIG. 3 is a schematic illustration of a distributed ledger system 300 for a smart contracting platform to reduce fraud in non-fungible tokens, according to an embodiment. The distributed ledger network can be, for example, a blockchain network and include multiple computing nodes 302a-302e. In some implementations, the distributed ledger network can be or include the distributed ledger network 217 as previously described in FIG. 2. Each computing node can be configured to communicate with each other via a peer-to-peer (P2P) connection. In some implementations, the computing nodes 302a-302e can include compute devices structurally and/or functionally similar to a compute device 101 described previously in FIG. 1 and/or a compute device 201 described previously in FIG. 2. In some implementations, the computing nodes 302a-302e can also be or include the first user compute device 130 and/or the second user compute device 132 described previously in FIG. 1. In some cases, any one of the computing nodes 302a-302e can be or include the compute device 101 from FIG. 1 and/or the compute device 201 from FIG. 2. In some implementations, the P2P connections can be provided by wired and/or wireless communications systems or networks (not shown) such as, for example, intranet, local area networks (LANs), wide area networks (WANs), etc., using wireless communication protocols or standards such as WiFi®, LTER, WiMAX®, and/or the like.

In some embodiments, the distributed ledger network can include (e.g., store) self-executing codes or smart contracts that are configured to execute upon validation and/or verification of, for example, transactions, records of transactions, completion of actions, and/or the like, associated with T-IDRs on the distributed ledger network. For example, some or all of the computing nodes 302a-302e can include copies of a smart contract (T-IDR-SC as previously described in FIG. 1 or FIG. 2) that self-executes upon validation and/or verification. In some implementations, each of the computing nodes 302a-302e can also store (or store copies of) the T-IDR-SC 120, the DR-SC 111, and/or the gatekeeper app 106 described previously in FIG. 1, and/or the T-IDR-SC 220, the DR-SC 211, and/or the gatekeeper app 206 described previously in FIG. 2. In some implementations, the computing nodes 302a-302e can communicate among each other to arrive at a consensus for approving a transaction of a T-IDR. In some implementations, a computing node(s) 302a-302e can have a smart contract(s) that self-executes, and produces a result determining whether or not the parties involved in a transaction of the T-IDR are verified and to be transmitted to the rest of the computing nodes 302a-302e for confirmation.

In some embodiments, the distributed ledger network can be linked to one or more oracles (not shown in FIG. 3) or data feeds that provide external data to the distributed ledger network. For example, an oracle can be hardware (e.g., computing node) or software (stored and/or executing on hardware) that is configured to gather or receive data from systems external to the distributed ledger network (e.g., sensors, web API, distributed ledger network, user compute devices, etc.) and can provide the collected data or information to a smart contract on the distributed ledger network. In some implementations, as discussed above, self-executing code or smart contracts can automatically execute upon realization of conditions of correctness and/or existence (e.g., actions 112 previously described in FIG. 1) of a transaction associated with a T-IDR, and the oracles may provide data that can be used to evaluate whether the conditions are met. The smart contract, upon receiving the information, may self-execute after determining validation and/or verification that the T-IDR transaction has been fulfilled. In some embodiments, the oracles may facilitate for the smart contracts to send data to external systems. For example, a smart contract can be configured to verify the T-IDR, involved parties, and/or other conditions, provided by users at a certain date and time, and send a verification result and/or a confirmation of execution/validation of the T-IDR, involved parties, and/or other conditions back to the users when the verification is complete.

In some implementations, at least a significant number of the computing nodes 302a-302e can include copies of a distributed ledger 304a-304e onto which T-IDR transactions that occur on the network are recorded (e.g., stored, synchronized, updated, etc.). For instance, all computing nodes may not have the same and/or updated version of the distributed ledger 304a-304e. The computing nodes may eventually have the same and/or updated version of the distributed ledger 304a-304e in response to a consensus formed by a sufficient and/or majority number of computing nodes (e.g., consensus in confirming whether or not the T-IDR, transaction of the T-IDR, recipient and sender of T-IDR, are correct). As such, the distributed ledgers 304a-304e are configured to be synched. The recording of the T-IDR and/or T-IDR transaction on the distributed ledger 304a-304e can occur when some significant number (e.g., a predetermined threshold, a predetermined fraction, etc.) of the computing nodes 302a-302e, or a subset thereof, agree on the validity of the T-IDR and/or T-IDR transaction. The distributed ledger 304a-304e can be immutable in response to a consensus being obtained from a significant number of computing nodes 302a-302e. In some implementations, the distributed ledger 304a-304e can be nearly immutable in the sense that to alter the distributed ledger 304a-304e, at least this significant number of the computing nodes 302a-302e would have to agree, which can be increasingly difficult when the number of computing nodes 302a-302e is large (and the distributed ledger 304a-304e gets longer).

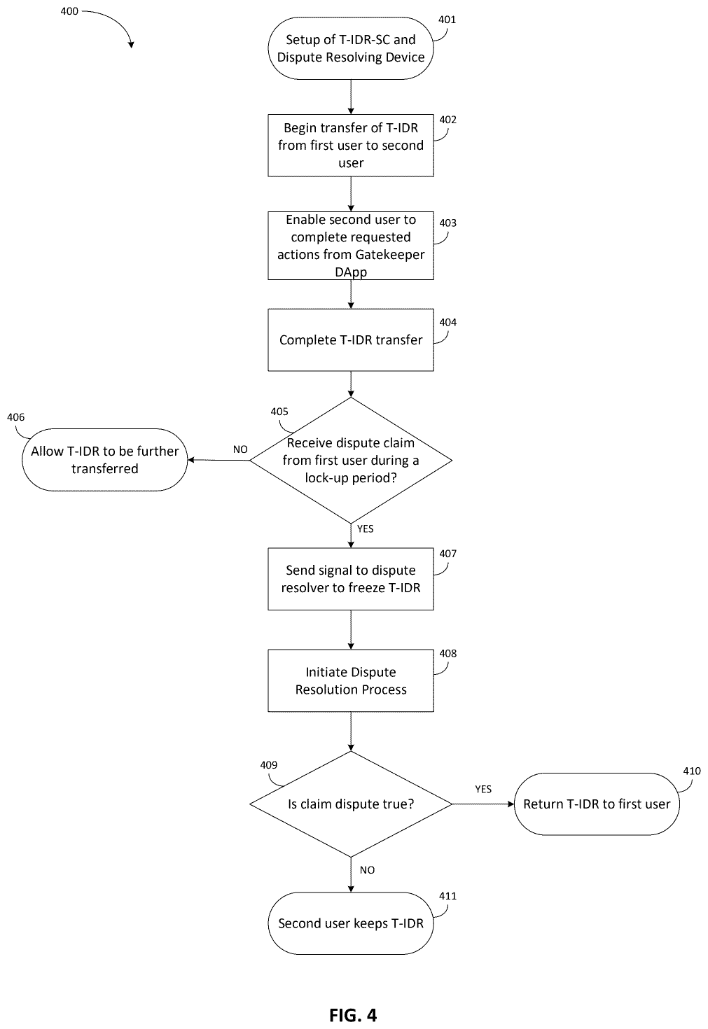

FIG. 4 is a flow diagram of a method 400 for a smart contracting platform to reduce fraud in non-fungible tokens, according to an embodiment. In some implementations, the method 400 can be executed at a processor of a compute device, such as, for example, the processor 102 of the compute device 101 in FIG. 1. At 401, the method includes setting up, generating and/or deploying a T-IDR-SC, a dispute resolving device (e.g., DR and/or DR-SC), and a gatekeeper app. The T-IDR-SC and/or DR-SC and/or gatekeeper app can be generated, executed and/or deployed by the compute device or the DR. The DR can be deployed and/or generated by the compute device. In some cases, the DR, the DR-SC, the T-IDR, and the gatekeeper app can be executed and/or deployed by the same or different entities. In some implementations, the method 400 can include executing and/or enabling an execution of the DR, the DR-SC, the T-IDR, and/or the gatekeeper app when deployed/generated.

At 402, the method 400 includes beginning a transfer of a T-IDR implemented and/or generated by the T-IDR-SC from a first user operating a first user compute device to a second user operating a second user compute device.

At 403, the method 400 includes enabling the second user to complete a requested action and/or a set of requested actions generated by a gatekeeper app. In some implementations, the method 400 can include displaying, to the second user compute device operated by the second user, the requested action associated with the T-IDR to be completed by the second user using an address (e.g., EVM address) of the second user. The requested action can include a T&C (e.g., a digital agreement) to be digitally signed by the second user using the second user's EVM blockchain address. The requested action can also be mandated by the T-IDR-SC. The completion of the requested action by the second user can create and/or define a verifiable contractual relationship between the first user and the second user anonymously. In some cases, the gatekeeper app can transmit a record of a digital signature used to complete the requested action of the second user to the T-IDR-SC, which stores the record on a distributed ledger of a distributed ledger network, enabling the record to be used for both restricting access to the T-IDR and/or for dispute resolution processes.

At 404, the method 400 includes completing the transfer of the T-IDR from the first user to the second user. In some implementations, the method 400 can include locking the T-IDR for a duration of time to prevent the T-IDR from being further transferred. In some cases, the method 400 can also include disabling alternative transfers of the T-IDR via a disabler component of the T-IDR-SC. For instance, the disabler component can be called and/or triggered to lock the T-IDR and disable the T-IDR from being transferred further for a predefined time period. This is so, at least in part, to secure the transfer of the T-IDR and provide to the first user and/or the second user time to submit, send and/or broadcast a dispute claim regarding the transfer of the T-IDR if necessary.

At 405, the method 400 includes a conditional check to check if a dispute claim has been received from the first user during the lock-up period. The dispute claim can include data indicating that the first user believes the second user has acquired the T-IDR maliciously, illegitimately, fraudulently and/or the like. In some cases, the dispute claim can be based on the transfer of the T-IDR from the first user to the second user.

At 406, the method 400 includes allowing the T-IDR to be further transferred in other transactions if no dispute claim has been received. In some cases, at 406, the transfer of the T-IDR from the first user to the second user remains completed if no dispute claim has been received. In some cases, the method 400 can include restarting the transfer process of the T-IDR and/or a different T-IDR at 402.

At 407, the method 400 includes sending a signal to the DR or DR-SC to freeze and/or disable the T-IDR in response to receiving a dispute claim from the first user. The T-IDR at this point can be halted from the transfer process until a dispute between the first user and the second user is resolved. Resolution of the dispute can be facilitated by the DR or DR-SC by checking records of the requested action from the gatekeeper app that were completed by the second user. In some implementations, the DR or DR-SC can be callable using a signed transaction from the address of the first user. In some cases, the signed transaction can include an identifier (token ID) of the T-IDR and a public decentralized ledger address.

At 408, the method includes initiating a dispute resolution process to resolve the dispute claim. In some implementations, the method 400 can include enabling the first user and/or the second user to follow a set of instructions such as, for example, providing information, digital signatures, proof of completion of requested actions, and/or the like. In some implementations, the method 400 can include triggering and/or automatically triggering a dispute component of the DR or DR-SC to initiate the dispute resolution process to resolve the dispute claim.

At 409, the method 400 includes confirming if the dispute claim is true, based on a decision by the DR operator and/or verification of records. In some implementations, the method 400 can include resolving by triggering an action check component of the T-IDR, to verify the address (e.g., EVM address) of the second user and if the requested action was completed by the second user.

At 410, the method 400 includes, in response to the dispute claim being true, the T-IDR is unfrozen and/or enabled and returned to the first user.

At 411, the method 400 includes, in response to the dispute claim being false, the T-IDR is unfrozen and/or enabled, and remains with the second user.

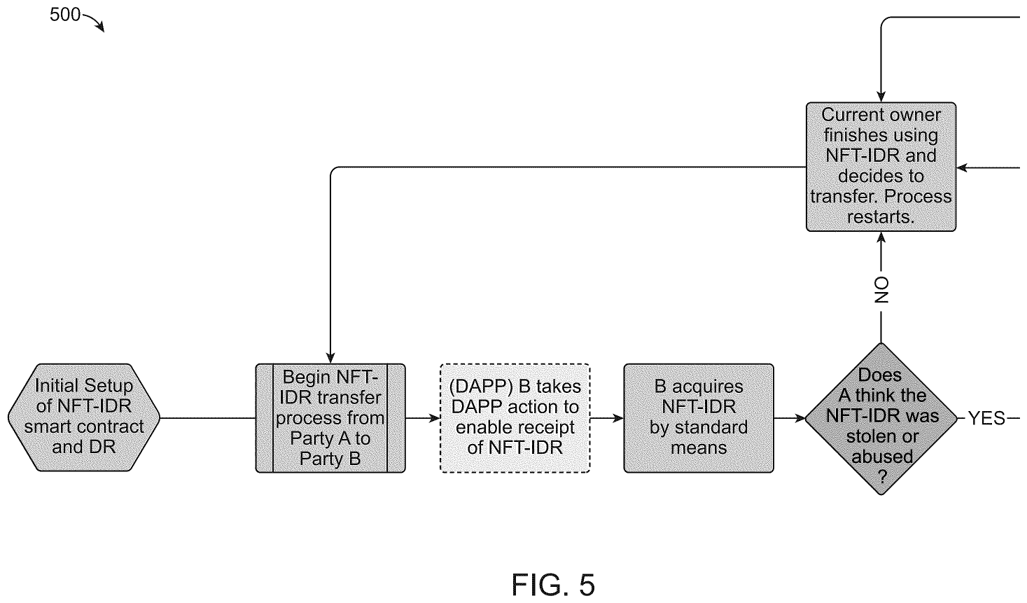

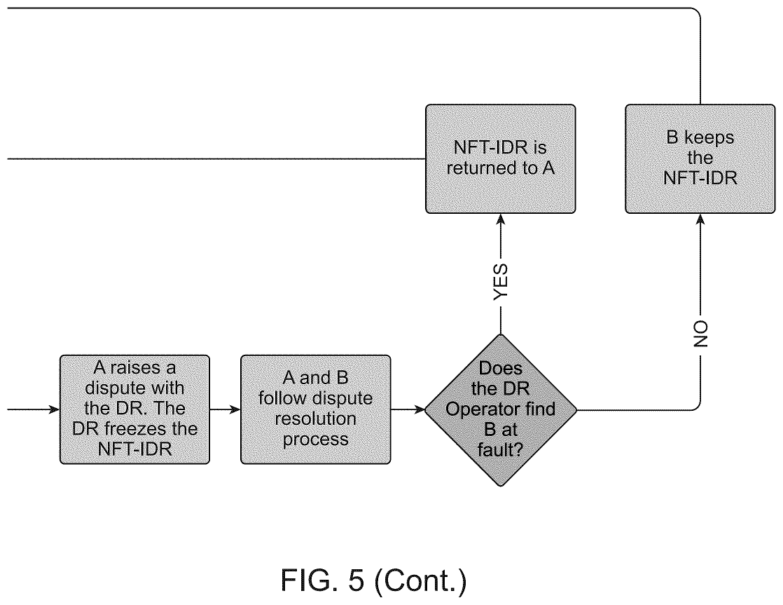

FIG. 5 is another flow diagram of a method 500 for a smart contracting platform to reduce fraud in non-fungible tokens, according to an embodiment. The method 500 can include resolving a dispute claim over a transfer of an NFT-IDR (or any other type of T-IDR). In some cases, in response to the dispute claim being invalid (or false), the receiver of the NFT-IDR can be enabled to perform other transactions with the NFT-IDR. In cases in which a dispute claim is not received, the receiver of the NFT-IDR can conduct future transactions. The steps of the method 500 can be stored and/or executed in a memory and/or processor of one of more devices (e.g., the devices shown and described with respect to FIG. 1).

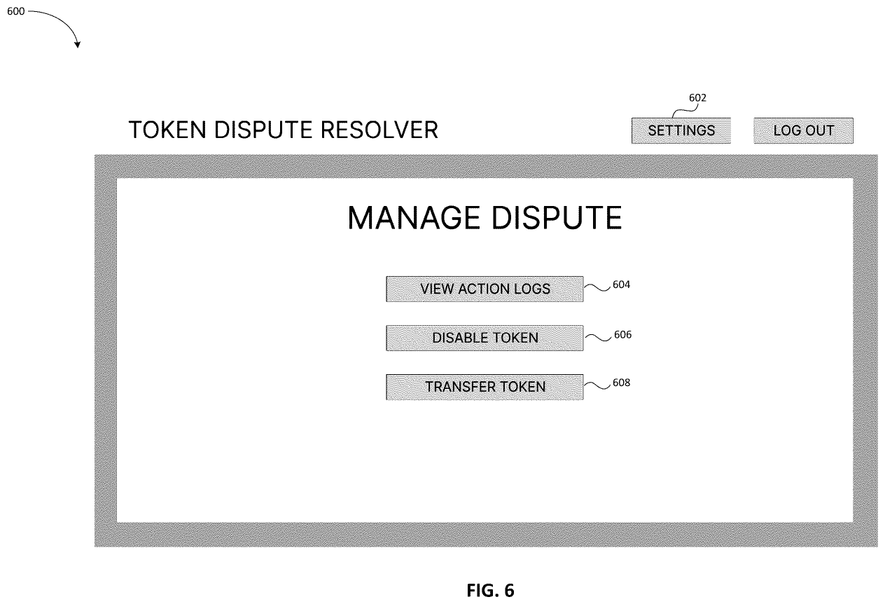

FIG. 6 is a block diagram illustrating a user interface 600 included in, implemented by, and/or for interacting with a dispute resolution system (e.g., a system structurally and/or functionally similar to the system 100 of FIG. 1), according to an embodiment. In some instances, at least a portion of the user interface 600 can be software stored at a memory and/or executed by a processor, of a compute device (e.g., a compute device structurally and/or functionally equivalent to, with respect to FIG. 1, the first user compute device 130, the second user compute device 132, and/or the compute device 101; with respect to FIG. 2, the compute device 201; and/or with respect to FIG. 7, the compute device 701). In some embodiments, at least a portion of the user interface 600 can be implemented in hardware. The user interface 600 can be functionally and/or structurally equivalent to the user interface 713 of FIG. 7, described herein. In some implementations, the user interface 600 can be a graphical user interface. The user interface 600 can include a settings selectable element 602, an action logs selectable element 604, a disable token selectable element 606, and/or a transfer token selectable element 608. A selectable element can include, for example, a link, button, etc., that a user can interact with to perform an action and/or view an additional user interface(s). Although not shown in FIG. 6, in some implementations, the user interface 600 can include an interface for generating and/or managing a DR-SC, a T-IDR-SC 220, and/or a gatekeeper object(s).

The action logs selectable element 604 can include a human-readable representations of, for example, records (e.g., that are functionally and/or structurally similar to records 114 of FIG. 1) and/or requested actions (e.g., that are functionally and/or structurally similar to requested actions 112 of FIG. 1). In some instances, these records and/or requested actions can be related to a current dispute. In some instances, the action logs selectable element 604 can facilitate viewing of an action register (e.g., that is functionally and/or structurally similar to the action register 126 of FIG. 1).

The disable token selectable element 606 can be configured to send (1) a token identifier of a T-IDR (e.g., that is similar to the action register 226 of FIGS. 2) and (2) an address of a T-IDR-SC (e.g., that is similar to the T-IDR-SC 220 of FIG. 2) to a T-IDR-SC caller (e.g., that is similar to the T-IDR-SC caller 724 of FIG. 7, described herein), and the T-IDR-SC caller can, in response, generate a signed message (e.g., a transaction) calling a disabler function (e.g., that is similar to and/or associated with the disabler component 224 of FIG. 2) defined by the T-IDR-SC. In response, the disabler function can add the token ID to an action register (e.g., that is similar to the action register 226 of FIG. 2) and/or blacklist, such that a transfer of the token can fail when the T-IDR-SC's transfer function calls an action check (e.g., that is similar to the action check component 225 of FIG. 2). Alternatively or in addition, in some implementations, the disabler function can send an account ID (e.g. that is associated with a user compute device similar to the second user compute device 132 of FIG. 1) to a T-IDR-SC caller instead of a token ID to prevent any of that account's tokens that are associated with that smart contract from being transferred.

The transfer token selectable element 608 can be configured to send an address associated with the DR 711, an address of a transfer recipient, a token ID of a T-IDR (e.g., that is similar to the T-IDR 219a of FIG. 2), and an address of a T-IDR-SC (e.g., that is similar to the T-IDR-SC 220 of FIG. 2) to a T-IDR-SC caller (e.g., that is similar to the T-IDR-SC caller 724 of FIG. 7, described herein), and the T-IDR-SC caller can, in response, generate a signed message (e.g., a transaction) calling a transfer function defined by the T-IDR-SC.

FIG. 7 is a block diagram of a dispute resolver (DR) system 700, according to an embodiment. In some implementations, the DR system 700 can be functionally and/or structurally equivalent to at least a portion of the system 100 of FIG. 1. For example, the DR system 700 can be configured to generate, deploy, and/or manage a smart contract, a token with integrated dispute resolution functionality, etc. The DR system 700 can include client compute devices 730 and 732 and a compute device 701. The client compute devices 730 and 732 can each be structurally and/or functionally equivalent to the first user compute device 130 and/or the second user compute device 132 of FIG. 1. For example, respective users of the client compute devices 730 and 732 can be parties to a transaction, smart contract, etc.

The compute device 701 can include a dispute resolver (DR) 711, which can include software executed by a processor (e.g., a processor functionally and/or structurally equivalent to the processor 102 of FIG. 1) of the compute device 701. In some instances, the DR 711 can be implemented in hardware. In some implementations, the compute device 701 can be a distributed ledger node associated with a distributed network, and the dispute resolver 711 can be a smart contract and/or an application deployed on the distributed network. The dispute resolver 711 can include a client interface 712, an account manager 702, a token manager 703, and a distributed ledger interface 721. The client interface 712 can include a user interface 713, which can be structurally and/or functionally similar to, for example, the user interface 600 of FIG. 6, and an application programming interface (API) 714, which can programmatically facilitate access between the DR resolver 711 and at least one of the client compute devices 730 and/or 732.

The account manager 702 can be configured to manage, for example, per-account cryptographic metadata (e.g., public/private keys) used for signing and submitting transactions to a distributed ledger network. For example, the account manager 702 can facilitate account creation, user logins, cryptographic metadata retrieval for authenticated users, etc. The token manager 703 can be configured to process token-related operations (e.g., operations requested via the client interface 712) by a user(s) of the client compute devices 730 and/or 732. Such operations can include, for example, creating a new data segment (e.g., a T-IDR) on a distributed ledger network, transferring a quantity of data segments from a sender to a receiver, minting a quantity of a data segment, burning a quantity of data segments (e.g., sending a token to an inaccessible address to remove the token from an available supply), querying metadata regarding a data segment, etc.

The distributed ledger interface 721 can include a smart contract (SC) generator 722, a dispute component 723, and a T-IDR-SC caller 724. The dispute component 723 can be functionally and/or structurally equivalent to the dispute component 113 of FIG. 1, and the T-IDR-SC caller 724 can be structurally and/or functionally equivalent to the T-IDR-SC caller 115 of FIG. 1. The SC generator 722 can be configured to generate at least one of a DR-SC (e.g., a DR-SC functionally and/or structurally equivalent to at least a portion of the DR-SC 111 of FIG. 1 and/or the DR-SC 211 of FIG. 2), a T-IDR-SC (e.g., a T-IDR-SC structurally and/or functionally equivalent to the T-IDR-SC 120 of FIG. 1 and/or the T-IDR-SC 220 of FIG. 2), and/or a gatekeeper app (e.g., a gatekeeper app structurally and/or functionally equivalent to the gatekeeper app 106 of FIG. 1 and/or the gatekeeper app 206 of FIG. 2).

In use, the DR 711, executed via the compute device 701, can generate, execute, and/or deploy software components to implement a system that is structurally and/or functionally equivalent to at least a portion of the system 100 of FIG. 1. For example, in some implementations, the DR system 700 can generate, execute and/or deploy a gatekeeper app (e.g., a component structurally and/or functionally similar to the gatekeeper app 106 of FIG. 1). The DR system 700 can also generate, execute, and/or deploy a smart contract (e.g., a component structurally and/or functionally similar to the DR-SC 111 of FIG. 1). In some cases, the DR-SC 111 and the gatekeeper app 106 can be generated, executed and/or deployed by different entities (e.g., other compute devices) not shown in FIG. 7. In some implementations, rather than generate a component similar to the DR-SC 111 of FIG. 1, the DR 711 can be configured to implement and/or perform similar functionality as to DR-SC 111, using the dispute component 723 and/or the T-IDR-SC caller 724. In some cases, the DR system 700 can further generate, execute and/or deploy a T-IDR-SC (e.g., a T-IDR-SC structurally and/or functionally equivalent to the T-IDR-SC 120 of FIG. 1) to mint a T-IDR (e.g., a T-IDR structurally and/or functionally equivalent to the T-IDR 119 of FIG. 1) and transfer the T-IDR to an owner (e.g., a user of the client compute device 730 or 732).

To illustrate an example use of the DR 711, the DR 711 can be configured to receive input data from a user (e.g., a user of the client compute device(s) 730 and/or 732) via the client interface 712 (e.g., via the user interface 713 and/or the API 714). The input data can specify, for example, token count, metadata, and/or other features of a smart contract, blockchain transaction, etc. The input data can also specify, for example, parameters particular to the DR 711, such as parameters associated with an action register, the dispute component 723, a locker component, etc. Based on this input data, the DR 711 can use the smart contract generator 722 to generate and/or deploy a smart contract (e.g., a T-IDR-SC) on a distributed ledger. In some implementations, as shown in FIG. 7, the DR 711 can implement the functionality of the dispute component 723 and/or the T-IDR-SC caller 724, rather than, for example, a generated DR-SC implementing that functionality (e.g., as shown in FIG. 1). For example, to effectuate a token transfer, an address associated with DR 711, an address of the transfer recipient, a token ID of a T-IDR generated by the T-IDR-SC, and/or an address of the T-IDR-SC can be passed to the T-IDR-SC caller 724, which, in response, can generate a signed transaction calling a standard or modified transfer function to cause a transfer of the T-IDR to recipient. In some instances, a gatekeeper token and/or a gatekeeper VC can be configured using the client interface 712 and/or deployed using the distributed ledger interface 721.

Using a standard transfer function, the DR 711 address can have been previously approved by an owner of a T-IDR, allowing the DR 711 to transfer the owner's tokens. To facilitate such an approval, the approval for the DR 711 address can be set within the DR 711 (e.g., via the client interface 712) as part of requested action (e.g., a requested action functionally equivalent to the requested actions 112 of FIG. 1). Alternatively, using a modified transfer function, the DR 711 can have privileges to cause transfer functions, approval functions, etc., to be modified during smart contract deployment to have authorization bypass capabilities. Those capabilities can then be assigned to the address of DR 711.

In addition to implementing a forced transfer, the DR 711 can call other functions to resolve a breach, including forcibly transferring cryptographic data segments (including fungible tokens), different from the T-IDR 819, owned by the breaching account. Permissions for such forcible transfers may be obtained beforehand during recipient validation of the breaching account using methods similar to those for obtaining permissions for T-IDR forcible transfers. Functions called by the DR 711 to resolve a breach may also include sending cryptographic data segments to web servers in order to cause the transfer of fiat money and/or other assets, and/or to update records flagging the owner of a breaching account for scrutiny.

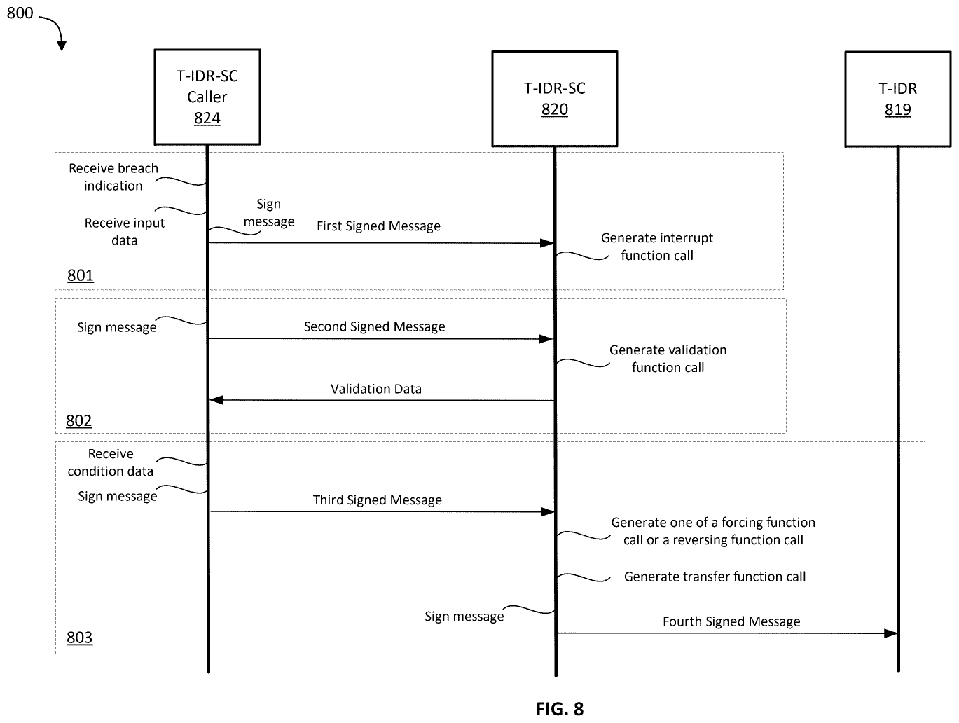

FIG. 8 is a schematic diagram illustrating a plurality of interaction sets 801-803 (e.g., dataflows, transmissions, signals, messages, function calls, and/or the like.) between logic components 800 to facilitate secure transfer of cryptographic data segments, according to an embodiment. The logic components 800 can be associated a compute device that is structurally and/or functionally similar to at least a portion of the compute device 101 of FIG. 1, the compute device 201 of FIG. 2, and/or the compute device 701 of FIG. 7. In some instances, for example, the logic components 800 can be implemented as software stored in memory 104 and configured to be executed via the processor 102 of FIG. 1. For example, at least a portion of the logic components 800 can be included in a DR that is functionally and/or structurally similar to the DR 711 of FIG. 7. In some instances, for example, at least a portion of the logic components 800 can be implemented in hardware. The logic components 800 include a T-IDR-SC caller 824 (which can be functionally and/or structurally similar to, for example, the T-IDR-SC caller 115 of FIG. 1 and/or the T-IDR-SC caller 724 of FIG. 7), a T-IDR-SC 820 (which can be functionally and/or structurally similar to, for example, the T-IDR-SC 120 of FIG. 1 and/or a smart contract generated by the smart contract generator 722 of FIG. 7), and a T-IDR 819 (which can be functionally and/or structurally similar to, for example, the T-IDR 119 of FIG. 1).

The T-IDR-SC caller 824 and the T-IDR-SC 820 can implement at a least a portion of a first interaction set 801. Specifically, the T-IDR-SC caller 824 can receive (e.g., from a user interface and/or a DR, as described in FIG. 7) a breach indication (e.g., a dispute claim), at least one of an identifier of the T-IDR 819 (e.g., an ID for a cryptographic data segment), and/or an address of the T-IDR-SC 820. A breach indication can be initiated, for example, by a previous owner (e.g., a first user) and received at the DR, for example, after the T-IDR 819 has been transferred from the previous owner to a recipient (e.g., a second user, current owner, etc.). In some instances, the T-IDR 819 can remain in the possession of the recipient while the DR adjudicates the dispute associated with the breach indication. In some instances, the T-IDR 819 can be transferred from the recipient to an intermediary (e.g., an escrow entity, etc.) while the DR adjudicates the dispute associated with the breach indication. In some instances, the T-IDR 819 can be transferred from the recipient to the previous owner while the DR adjudicates the dispute associated with the breach indication. The address of the T-IDR-SC 820 can include a public key, and in response to receiving the breach indication and based on the input data, the T-IDR-SC caller 824 can encrypt a first message based on this public key, where the first message includes the identifier of the T-IDR 819. The T-IDR-SC 820 caller can further sign the first message based on a private key associated with the T-IDR-SC caller 824, generating a first signed message that includes a verification indication representing a digital signature. The first signed message can be received by the T-IDR-SC 820 (e.g., via a distributed network), which can cause the T-IDR-SC 820 to generate an interrupt function call. The interrupt function call can be associated with a function defined and/or implemented by the T-IDR-SC 820. Specifically, the interrupt function call can cause the identifier of the T-IDR 819 to be added to a register (e.g., a table or similarly suited data structure) defined by the T-IDR-SC 820. As a result of the identifier of the T-IDR 819 being included in the register, the T-IDR 819 can be prevented from being transferred to the previous owner (e.g., a previous owner of the T-IDR 819), the recipient, and/or a third party (e.g., from the recipient).

The T-IDR-SC caller 824 and the T-IDR-SC 820 can also implement at a least a portion of a second interaction set 802. Specifically, based on input data (e.g., the input data received within the first interaction set 801), the T-IDR-SC caller 824 can generate a second signed message addressed to the T-IDR-SC 820 to cause the T-IDR-SC 820 to generate a validation function call. The validation function call can cause the T-IDR-SC 820 to cause a function defined by the T-IDR-SC 820 to return validation data (e.g., data similar to a gatekeeper token and/or a gatekeeper Verified Credential, described herein). The T-IDR-SC 820 can cause the validation data to be sent to the T-IDR-SC caller 824 (or a component and/or compute device associated with the T-IDR-SC caller 824, such as a DR, DR-SC, etc.). The T-IDR-SC caller 824 and/or the T-IDR-SC 820 can perform at least a portion of the second interaction set 802 before, after, and/or concurrent to performing at least a portion of (1) the first interaction set 801 and/or (2) the third interaction set 803. For example, in some instances, the second interaction set 802 can be performed before a breach indication is received at the DR and/or before the T-IDR 819 is transferred from the previous owner to the recipient, such that the recipient is validated prior to receiving the T-IDR 819. In other instances, based on the validation data, which can be used to verify an identity of the previous owner and/or the recipient and/or the previous owner's respective qualifications to hold the T-IDR 819 (as described herein), the T-IDR-SC 820 can be configured to generate the first signed message and/or a third signed message (described below).

The T-IDR-SC caller 824 and the T-IDR-SC 820 can also implement at a least a portion of a third interaction set 803. Specifically, based on input data (e.g., the input data received within the first interaction set 801) and condition data, the T-IDR-SC caller 824 can generate a third signed message addressed to the T-IDR-SC 820. The condition data can include one of (1) an indication that a previous owner or a recipient has satisfied a condition(s) defined by the T-IDR-SC 820 or (2) an indication that the previous owner or recipient has not satisfied the condition(s). A condition can be predicated on, for example, a requested action and/or an action that can be recorded in an action register, as described herein. In response to receiving the third signed message, the T-IDR-SC 820 can generate one of a release function call or a forcing function call. For example, if the second signed message indicates that the condition(s) has been satisfied by the recipient, the T-IDR-SC 820 can generate the release function call, which in turn can cause the identifier of the T-IDR 819 to be removed from the register, permitting the recipient to maintain unencumbered possession of the T-IDR 819 and/or facilitating the transfer of the T-IDR 819 back to the recipient (e.g., based on a subsequent transfer function call performed by T-IDR-SC 820). If the second signed message indicates instead that the condition(s) has not been satisfied by the recipient, the T-IDR-SC 820 can generate the forcing function call, which in turn can cause the identifier for the T-IDR 819 to remain in the register, preventing the T-IDR 819 from being spent by the recipient and/or encumbering the recipient's possession of the T-IDR 819. In some instances, based on the forcing function call, the T-IDR-SC 820 can generate a transfer function call to cause the T-IDR 819 to be transferred to the previous owner (e.g., if the previous owner was dispossessed of the T-IDR 819 prior to the breach indication being received by the T-IDR-SC caller 824). In some instances, the previous owner may not have satisfied a condition(s). For example, in the event that a previous owner has failed to perform a duty, the T-IDR-SC 820 can generate the release function call.

In some instances, the T-IDR 819 can be associated with a lock-up period after the T-IDR 819 has been transferred and/or undergone a change in ownership. The T-IDR-SC 820 can be configured to check a time associated with a previous transfer of the T-IDR 819 and a predefined time period (e.g., a time period specified by a transferor of the T-IDR 819 prior to the previous transfer). Based on the time and the predefined time period, the T-IDR-SC 820 can be configured to determine if sufficient time has passed (e.g., as specified by the predefined time period) permit a subsequent transfer of the T-IDR 819.

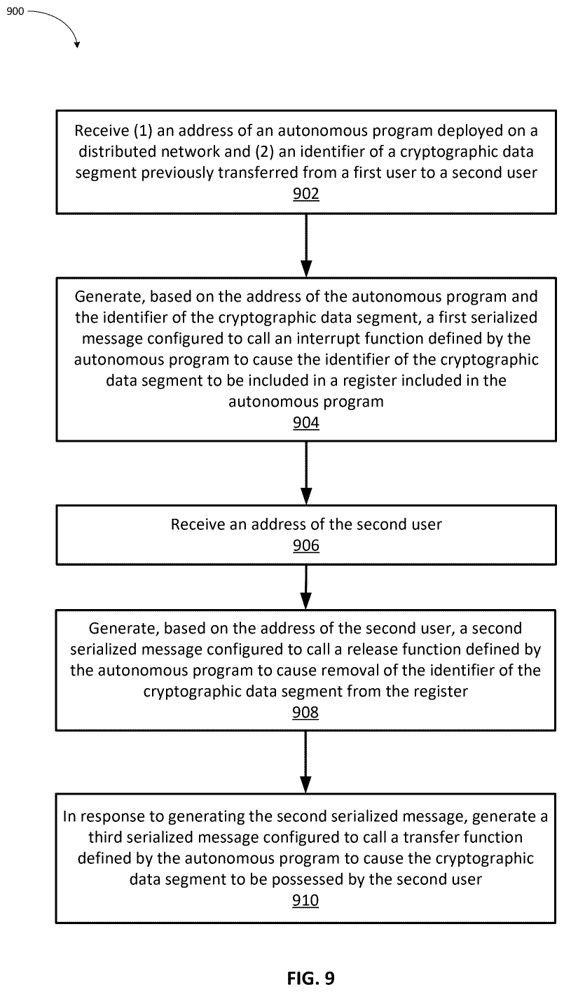

FIG. 9 is a flow diagram illustrating a method 900 implemented by a system configured to facilitate the secure transfer of cryptographic data segments, according to another embodiment. The method 900 can be implemented by a system functionally and/or structurally similar to, for example, the system 100 of FIG. 1 and/or the DR system 700 of FIG. 7.

At 902, the method 900 includes receiving (1) an address of an autonomous program deployed on a distributed network and (2) an identifier of a cryptographic data segment (a) deployed on the distributed network and (b) previously transferred from a first user to a second user. The method 900 at 904 includes generating, based on the address of the autonomous program and the identifier of the cryptographic data segment, a first serialized message configured to call an interrupt function defined by the autonomous program to cause the identifier of the cryptographic data segment to be included in a register included in the autonomous program. At 906, an address of the second user is received, and at 908, the method 900 includes generating a second serialized message configured to call a release function defined by the autonomous program to cause removal of the identifier of the cryptographic data segment from the register. In response to generating the second serialized message, at 910, the method 900 includes generating a third serialized message configured to call a transfer function defined by the autonomous program to cause the cryptographic data segment to be possessed by the second user. In some instances, causing the cryptographic data segment to be possessed by the second user can include transferring the cryptographic data segment to the second user. In other instances, causing the cryptographic data segment to be possessed by the second user can include permitting the cryptographic data segment to be retained by the second user.

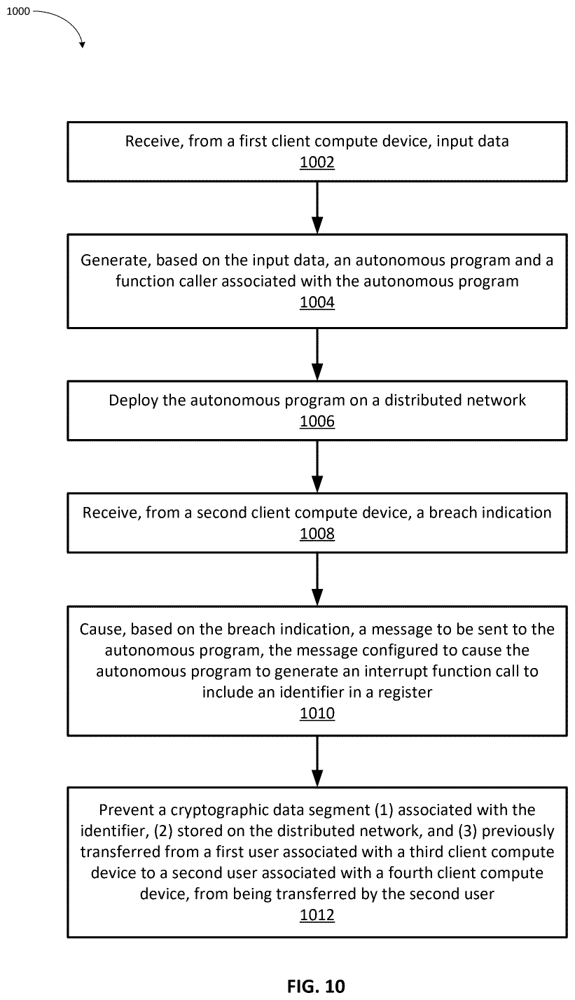

FIG. 10 is a flow diagram illustrating a method 1000 implemented by a system configured to facilitate the secure transfer of cryptographic data segments, according to another embodiment. The method 1000 can be implemented by a system functionally and/or structurally similar to, for example, the system 100 of FIG. 1 and/or the DR system 700 of FIG. 7.

The method 1000 at 1002 includes receiving, from a first client compute device, input data, and at 1004, the method 1000 includes generating, based on the input data, an autonomous program and a function caller associated with the autonomous program. At 1006, the autonomous program is deployed on a distributed network, and at 1008, a breach indication is received from a second client compute device. Based on the breach indication, at 1010, the method 1000 includes causing a message to be sent to the autonomous program. The message is configured to cause the autonomous program to generate an interrupt function call to include an identifier in a register. The method 1000 at 1012 includes preventing, based on the identifier being included in the register, a cryptographic data segment (1) associated with the identifier, (2) stored on the distributed network, and (3) previously transferred from a first user associated with a third client compute device to a second user associated with a fourth client compute device, from being transferred by the second user.

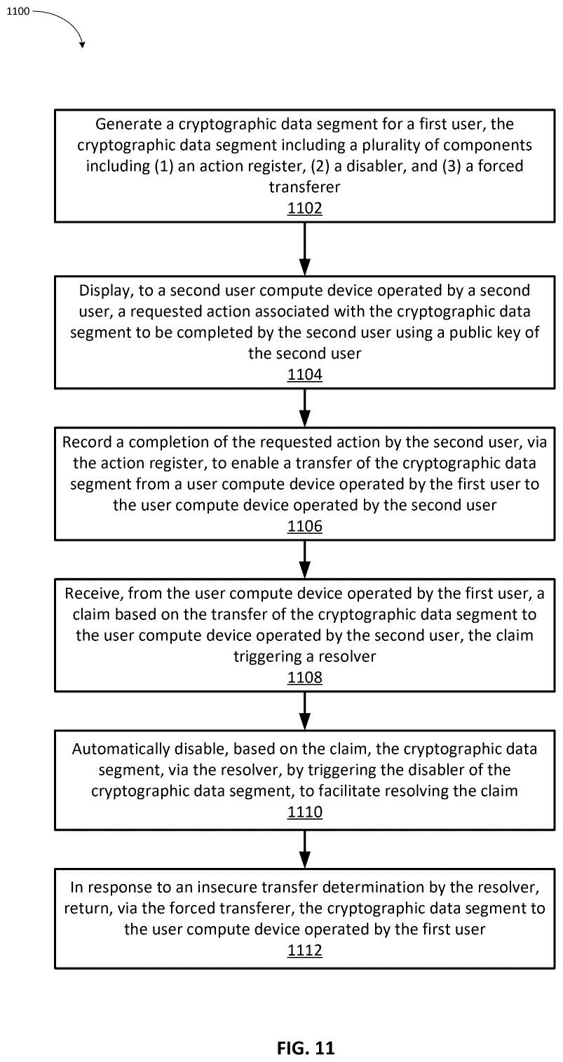

FIG. 11 is a flow diagram illustrating a method 1100 implemented by a system configured to facilitate the secure transfer of cryptographic data segments, according to another embodiment. The method 1100 can be implemented by a system functionally and/or structurally similar to, for example, the system 100 of FIG. 1 and/or the DR system 700 of FIG. 7.

At 1102, the method 1100 includes generating a cryptographic data segment for a first user. The cryptographic data segment includes a plurality of components including (1) an action register, (2) a disabler, and (3) a forced transferer. The method 1100 at 1104 includes displaying, to a second user compute device operated by a second user, a requested action associated with the cryptographic data segment to be completed by the second user using a public key of the second user. At 1106, the method 1100 includes recording a completion of the requested action by the second user, via the action register, to enable a transfer of the cryptographic data segment from a user compute device operated by the first user to the user compute device operated by the second user. From the user compute device operated by the first user, at 1108, a claim is received at the processor based on the transfer of the cryptographic data segment to the user compute device operated by the second user, the claim triggering a resolver. The method 1100 at 1110 includes automatically disabling, based on the claim, the cryptographic data segment, via the resolver, by triggering the disabler of the cryptographic data segment, to facilitate resolving the claim. In response to an insecure transfer determination by the resolver, at 1112, the cryptographic data segment is returned, via the forced transferer, to the user compute device operated by the first user.

In an embodiment, a non-transitory, processor-readable medium stores instructions to cause a processor to receive (1) an address of an autonomous program deployed on a distributed network and (2) an identifier of a cryptographic data segment (a) deployed on the distributed network and (b) previously transferred from a first user to a second user. The instructions further cause the processor to generate, based on the address of the autonomous program and the identifier of the cryptographic data segment, a first serialized message configured to call an interrupt function defined by the autonomous program to cause the identifier of the cryptographic data segment to be included in a register included in the autonomous program. The processor further generates, based on an address of a second user received at the processor, a second serialized message configured to call a release function defined by the autonomous program to cause removal of the identifier of the cryptographic data segment from the register. In response to generating the second serialized message, the instructions cause the processor to generate a third serialized message configured to call a transfer function defined by the autonomous program to cause the cryptographic data segment to be possessed by the second user.

In some implementations, the register can be a first register, and the instructions to generate the second serialized message can include instructions to retrieve, from a second register defined by the autonomous program, an indication that a condition defined by the autonomous program has been satisfied by the first user. The instructions can further include instructions to generate, based on the indication, the second serialized message. In some implementations, the register can be a first register, and the instructions to generate the second serialized message can include instructions to retrieve, from a second register defined by the autonomous program, an indication that a condition defined by the autonomous program has been satisfied by the first user. The instructions can further include instructions to generate, based on the indication, the second serialized message. In some implementations, the instructions to generate the second serialized message include instructions to generate, based on the address of the first user, a fourth serialized message configured to call a validation function defined by the autonomous program to produce validation data. The instructions can further include instructions to generate, based on the validation data, the second serialized message.

In some implementations, the instructions to generate the first serialized message include instructions to (1) receive a breach indication and (2) generate, based on the breach indication, the first serialized message. In some implementations, the non-transitory, processor-readable medium can further store instructions to cause the processor to prevent, based on (1) a first time associated with a previous transfer of the cryptographic data segment and (2) a predefined time period, the cryptographic data segment from being transferred.

In some implementations, the first serialized message can include a first validation identifier based on the address of the autonomous program, the second serialized message can include a second validation identifier based on the address of the autonomous program, and the third serialized message can include a third validation identifier based on the address of the recipient. In some implementations, the register can be a first register, and the non-transitory, processor-readable medium can further store instructions to cause the processor to (1) receive an address of a third user and (2) retrieve, from a second register defined by the autonomous program and based on the address of the third user, an indication that a condition defined by the autonomous program has not been satisfied by the third user. The instructions can further cause the processor to generate, based on the address of the third user, a fourth serialized message configured to call a forcing function defined by the autonomous program to cause the cryptographic data segment to transfer to the first user.

In an embodiment, a non-transitory, processor-readable medium stores instructions to cause a processor to (1) receive, from a first client compute device, input data and (2) generate, based on the input data, an autonomous program and a function caller associated with the autonomous program. The instructions further cause the processor to (1) deploy the autonomous program on a distributed network and (2) receive, from a second client compute device, a breach indication. Based on the breach indication, the processor causes a message to be sent to the autonomous program. The message is configured to cause the autonomous program to generate an interrupt function call to include an identifier in a register. The instructions also cause the processor to prevent, based on the identifier being included in the register, a cryptographic data segment (1) associated with the identifier, (2) stored on the distributed network, and (3) previously transferred from a first user associated with a third client compute device to a second user associated with a fourth client compute device, from being transferred by the second user.

In some implementations, the second client compute device can be the fourth client compute device. In some implementations, the second client compute device can be the third client compute device. In some implementations, the message can be a first message; and the non-transitory, processor-readable medium can further store instructions to cause the processor to cause, based on the breach indication, a second message to be sent to the autonomous program, the second message configured to cause the autonomous program to generate a validation function call that returns an indication that a condition defined by the autonomous program has been satisfied by the second user. The instructions can also cause the processor to, based on the indication that the condition has been satisfied by the recipient, generate a third message configured to cause the autonomous program to generate a transfer function to transfer the cryptographic data segment to the second user.

In some implementations, the message can be a first message, and the non-transitory, processor-readable medium can further store instructions to cause the processor to cause, based on the breach indication, a second message to be sent to the autonomous program, the second message configured to cause the autonomous program to generate a validation function call that returns an indication that a condition defined by the autonomous program has not been satisfied by the recipient. The instructions can also cause the processor to, based on the indication that the condition has not been satisfied by the second user, generate a third message configured to cause the autonomous program to generate a forcing function to transfer the cryptographic data segment to the first user. In some implementations, the autonomous program can be associated with a smart contract protocol. In some implementations, the message can be associated with a blockchain transaction.

In an embodiment, a non-transitory, processor-readable medium stores instructions to cause a processor to generate a cryptographic data segment for a first user, the cryptographic data segment including a plurality of components including (1) an action register, (2) a disabler, and (3) a forced transferer. The instructions also cause the processor to display, to a second user compute device operated by a second user, a requested action associated with the cryptographic data segment to be completed by the second user using a public key of the second user. Additionally, the instructions cause the processor to record a completion of the requested action by the second user, via the action register, to enable a transfer of the cryptographic data segment from a user compute device operated by the first user to the user compute device operated by the second user. From the user compute device operated by the first user, a claim is received at the processor based on the transfer of the cryptographic data segment to the user compute device operated by the second user, the claim triggering a resolver. The instructions also cause the processor to automatically disable, based on the claim, the cryptographic data segment, via the resolver, by triggering the disabler of the cryptographic data segment, to facilitate resolving the claim. In response to an insecure transfer determination by the resolver, the instructions cause the processor to return the cryptographic data segment to the user compute device operated by the first user via the forced transferer.

In some implementations, the completion of the requested action can include cryptographically signing a digital agreement generated by a gatekeeper distributed application, using the public key of the second user. In some implementations, resolving the claim can further include triggering an action checker from the plurality of components of the cryptographic data segment to verify the public key of the second user and the requested action completed by the second user. In some implementations, the resolver can be actuated using a cryptographically signed transaction from a public key of the first user, the cryptographically signed transaction including an identifier of the cryptographic data segment and a public distributed ledger address. In some implementations, the plurality of components can include a locker, and the non-transitory, processor-readable medium can further store instructions to cause the processor to disable a plurality of alternative transfers via the locker for a predefined time period.

It is to be noted that any one or more of the aspects and embodiments described herein can be conveniently implemented using one or more machines (e.g., one or more compute devices that are utilized as a user compute device for an electronic document, one or more server devices, such as a document server, etc.) programmed according to the teachings of the present specification. Appropriate software coding can readily be prepared by skilled programmers based on the teachings of the present disclosure. Aspects and implementations discussed above employing software and/or software modules can also include appropriate hardware for assisting in the implementation of the machine executable instructions of the software and/or software module.

Such software can be a computer program product that employs a machine-readable storage medium. A machine-readable storage medium can be any medium that is capable of storing and/or encoding a sequence of instructions for execution by a machine (e.g., a compute device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software can also include information (e.g., data) carried as a data signal on a data carrier, such as a carrier wave. For example, machine-executable information can be included as a data-carrying signal embodied in a data carrier in which the signal encodes a sequence of instruction, or portion thereof, for execution by a machine (e.g., a compute device) and any related information (e.g., data structures and data) that causes the machine to perform any one of the methodologies and/or embodiments described herein.

Examples of a compute device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a compute device can include and/or be included in a kiosk.

All combinations of the foregoing concepts and additional concepts discussed here within (provided such concepts are not mutually inconsistent) are contemplated as being part of the subject matter disclosed herein. The terminology explicitly employed herein that also can appear in any disclosure incorporated by reference should be accorded a meaning most consistent with the particular concepts disclosed herein.

The drawings are primarily for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments can be practiced. The advantages and features of the application are of a representative sample of embodiments only and are not exhaustive and/or exclusive. Rather, they are presented to assist in understanding and teach the embodiments and are not representative of all embodiments. As such, certain aspects of the disclosure have not been discussed herein. That alternate embodiments cannot have been presented for a specific portion of the innovations or that further undescribed alternate embodiments can be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments can be utilized and functional, logical, operational, organizational, structural and/or topological modifications can be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For example, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The term “automatically” is used herein to modify actions that occur without direct input or prompting by an external source such as a user. Automatically occurring actions can occur periodically, sporadically, in response to a detected event (e.g., a user logging in), or according to a predetermined schedule.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general-purpose processor, a central processing unit (CPU), a microprocessor, a digital signal processor (DSP), a controller, a microcontroller, a state machine and so forth. Under some circumstances, a “processor” can refer to an application specific integrated circuit (ASIC), a programmable logic device (PLD), a field programmable gate array (FPGA), etc. The term “processor” can refer to a combination of processing devices, e.g., a combination of a DSP and a microprocessor, multiple microprocessors, one or more microprocessors in conjunction with a DSP core or any other such configuration.

The term “memory” should be interpreted broadly to encompass any electronic component capable of storing electronic information. The term memory can refer to various types of processor-readable media such as random-access memory (RAM), read-only memory (ROM), non-volatile random-access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” can refer to one or more programs, routines, sub-routines, functions, procedures, etc. “Instructions” and “code” can comprise a single computer-readable statement or many computer-readable statements.

The term “modules” can be, for example, distinct but interrelated units from which a program may be built up or into which a complex activity may be analyzed. A module can also be an extension to a main program dedicated to a specific function. A module can also be code that is added in as a whole or is designed for easy reusability.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Various concepts can be embodied as one or more methods, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

In addition, the disclosure can include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein can be implemented in a manner that enables a great deal of flexibility and customization as described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A non-transitory, processor-readable medium storing instructions to cause a processor to:
receive (1) an address of an autonomous program deployed on a distributed network and (2) an identifier of a cryptographic data segment (a) deployed on the distributed network and (b) previously transferred from a first user to a second user;
generate, based on the address of the autonomous program and the identifier of the cryptographic data segment, a first serialized message configured to call an interrupt function defined by the autonomous program to cause the identifier of the cryptographic data segment to be included in a register included in the autonomous program;
receive an address of the second user;
generate, based on the address of the second user, a second serialized message configured to call a release function defined by the autonomous program to cause removal of the identifier of the cryptographic data segment from the register; and
in response to generating the second serialized message, generate a third serialized message configured to call a transfer function defined by the autonomous program to cause the cryptographic data segment to be possessed by the second user.

2. The non-transitory, processor-readable medium of claim 1, wherein:
the register is a first register; and
the instructions to generate the second serialized message include instructions to:
retrieve, from a second register defined by the autonomous program, an indication that a condition defined by the autonomous program has been satisfied by the second user; and
generate, based on the indication, the second serialized message.

3. The non-transitory, processor-readable medium of claim 1, wherein:
the register is a first register; and
the instructions to generate the third serialized message include instructions to:
retrieve, from a second register defined by the autonomous program, an indication that a condition defined by the autonomous program has been satisfied by the first user of the cryptographic data segment; and
generate, based on the indication, the third serialized message.

4. The non-transitory, processor-readable medium of claim 1, wherein the instructions to generate the second serialized message include instructions to:
generate, based on the address of the second user, a fourth serialized message configured to call a validation function defined by the autonomous program to produce validation data; and
generate, based on the validation data, the second serialized message.

5. The non-transitory, processor-readable medium of claim 1, wherein the instructions to generate the first serialized message include instructions to:
receive a breach indication; and
generate, based on the breach indication, the first serialized message.

6. The non-transitory, processor-readable medium of claim 5, further storing instructions to cause the processor to:
prevent, based on (1) a first time associated with a previous transfer of the cryptographic data segment and (2) a predefined time period, the cryptographic data segment from being transferred.

7. The non-transitory, processor-readable medium of claim 1, wherein:
the first serialized message includes a first validation identifier based on the address of the autonomous program;
the second serialized message includes a second validation identifier based on the address of the autonomous program; and
the third serialized message includes a third validation identifier based on the address of the second user.

8. The non-transitory, processor-readable medium of claim 1, wherein:
the register is a first register; and
the non-transitory, processor-readable medium further stores instructions to cause the processor to:
receive an address of a third user;
retrieve, from a second register defined by the autonomous program and based on the address of the third user, an indication that a condition defined by the autonomous program has not been satisfied by the third user; and
generate, based on the address of the third user, a fourth serialized message configured to call a forcing function defined by the autonomous program to cause the cryptographic data segment to transfer to the first user.

9. A non-transitory, processor-readable medium storing instructions to cause a processor to:
receive, from a first client compute device, input data;
generate, based on the input data, an autonomous program and a function caller associated with the autonomous program;
deploy the autonomous program on a distributed network;
receive, from a second client compute device, a breach indication;
cause, based on the breach indication, a message to be sent to the autonomous program, the message configured to cause the autonomous program to generate an interrupt function call to include an identifier in a register; and
prevent a cryptographic data segment (1) associated with the identifier, (2) stored on the distributed network, and (3) previously transferred from a first user associated with a third client compute device to a second user associated with a fourth client compute device, from being transferred by the second user.

10. The non-transitory, processor-readable medium of claim 9, wherein the second client compute device is the fourth client compute device.

11. The non-transitory, processor-readable medium of claim 9, wherein the second client compute device is the third client compute device.

12. The non-transitory, processor-readable medium of claim 9, wherein:
the message is a first message; and
the non-transitory, processor-readable medium further stores instructions to cause the processor to:
cause, based on the breach indication, a second message to be sent to the autonomous program, the second message configured to cause the autonomous program to generate a validation function call that returns an indication that a condition defined by the autonomous program has been satisfied by the second user; and
based on the indication that the condition has been satisfied by the second user, generate a third message configured to cause the autonomous program to generate a transfer function to cause the cryptographic data segment to be possessed by the second user.

13. The non-transitory, processor-readable medium of claim 9, wherein:
the message is a first message; and
the non-transitory, processor-readable medium further stores instructions to cause the processor to:
cause, based on the breach indication, a second message to be sent to the autonomous program, the second message configured to cause the autonomous program to generate a validation function call that returns an indication that a condition defined by the autonomous program has not been satisfied by the second user; and
based on the indication that the condition has not been satisfied by the second user, generate a third message configured to cause the autonomous program to generate a forcing function to transfer the cryptographic data segment to the first user.

14. The non-transitory, processor-readable medium of claim 9, wherein the autonomous program is associated with a smart contract protocol.

15. The non-transitory, processor-readable medium of claim 9, wherein the message is associated with a blockchain transaction.

16. A non-transitory, processor-readable medium storing instructions to cause a processor to:
generate a cryptographic data segment for a first user, the cryptographic data segment including a plurality of components including (1) an action register, (2) a disabler, and (3) a forced transferer;
display, to a second user compute device operated by a second user, a requested action associated with the cryptographic data segment to be completed by the second user using a public key of the second user;
record a completion of the requested action by the second user, via the action register, to enable a transfer of the cryptographic data segment from a user compute device operated by the first user to the user compute device operated by the second user;
receive, from the user compute device operated by the first user, a claim based on the transfer of the cryptographic data segment to the user compute device operated by the second user, the claim triggering a resolver;
automatically disable, based on the claim, the cryptographic data segment, via the resolver, by triggering the disabler of the cryptographic data segment, to facilitate resolving the claim; and
in response to an insecure transfer determination by the resolver, return the cryptographic data segment to the user compute device operated by the first user via the forced transferer.

17. The non-transitory, processor-readable medium of claim 16, wherein the completion of the requested action includes cryptographically signing a digital agreement generated by a gatekeeper distributed application, using the public key of the second user.

18. The non-transitory, processor-readable medium of claim 16, wherein resolving the claim further includes triggering an action checker from the plurality of components of the cryptographic data segment to verify the public key of the second user and the requested action completed by the second user.

19. The non-transitory, processor-readable medium of claim 16, wherein the resolver is actuated using a cryptographically signed transaction from a public key of the first user, the cryptographically signed transaction including an identifier of the cryptographic data segment and a public distributed ledger address.

20. The non-transitory, processor-readable medium of claim 16, wherein:
the plurality of components includes a locker; and
the non-transitory, processor-readable medium further stores instructions to cause the processor to disable a plurality of alternative transfers via the locker for a predefined time period.
